(19) United States
(12) Patent Application Publication
(10) Pub. No.: US 2005/0197141 A1
(43) Pub. Date: Sep. 8, 2005

(54) 'Back' button schema in mobile applications

(76) Inventors: Zhaowei Charlie Jiang, San Jose, CA (US); Christopher Wu, Atherton, CA (US); Joy Sato, San Jose, CA (US); Yingqing Lawrence Cui, San Jose, CA (US)

Correspondence Address: DECHERT LLP, P.O. BOX 10004, PALO ALTO, CA, 94303, US

(21) Appl. No.: 11/110,575

(22) Filed: Apr. 19, 2005

Related U.S. Application Data
(63) Continuation-in-part of application No. 10/868,416, filed on Jun. 14, 2004.
(60) Provisional application No. 60/518,898, filed on Nov. 10, 2003.
(60) Provisional application No. 60/518,858, filed on Nov. 10, 2003.
(60) Provisional application No. 60/518,857, filed on Nov. 10, 2003.
(60) Provisional application No. 60/518,897, filed on Nov. 10, 2003.

(51) Int. Cl. H04Q 7/20

(52) U.S. Cl. 455/457

(57) ABSTRACT

A wireless system includes a plurality of mobile devices having a ‘back’ command input that prompts backwards navigation. The system further includes a carrier network, a network including the Internet, and a server. The plurality of mobile devices are interconnected with the server via the carrier network and the network and are capable of communicating with each other via the server. One or more than one mobile devices has, in addition to the ‘back’ command input, a memory for receiving a mobile client application from the server. The mobile client application is responsive to the ‘back’ command input by providing for the backwards navigation through screens in ‘back in sequence’ mode and ‘back a level’ mode. The ‘back’ logic that provides the backwards navigation is implemented in the mobile client application outside the browser environment and independent of the platform.

### REFERENCE TO PRIOR APPLICATIONS

This application is a continuation-in-part of and incorporates by reference U.S. patent application Ser. No. 10/868,416, filed Jun. 14, 2004, and entitled “‘Back’ Button In Mobile Applications,” which claims the benefit of and incorporates by reference U.S. Provisional Application Ser. No. 60/518,898 entitled “BACK BUTTON IN MOBILE APPLICATION,” U.S. Provisional Application Ser. No. 60/518,858, entitled “NAVIGATION PATTERN ON A DIRECTORY TREE,” U.S. Provisional Application Ser. No. 60/518,857, entitled “BACKUP AND RESTORE IN MOBILE APPLICATIONS,” and U.S. Provisional Application Ser. No. 60/518,897, entitled “UPLOAD SECURITY SCHEME,” all of which were filed Nov. 10, 2003.

### FIELD OF THE INVENTION

The present invention relates generally to wireless devices and more particularly to mobile applications that implement the concept of “back button.” Among such applications, one type is a client-side mobile photos application.

### BACKGROUND

Mobile-friendly technologies are advanced to provide a rich multimedia environment and enhance the wireless device users’ experience. An outcome of this evolution is the manifest closeness between the wireless universe and the Internet domain, as well as the advent of wireless devices with multimedia capabilities. The newer versions of mobile wireless devices such as digital mobile phones, pagers, personal digital assistants (PDAs), handsets, and any other wireless terminals, have multimedia capabilities including the ability to retrieve e-mail, and push and pull information via the Internet.

Wireless protocols, the standards governing communications of data between wireless devices and the Internet, utilize and support the enhanced capabilities of these latest mobile wireless devices and Internet content technologies. Hypertext transfer protocol (HTTP) is an often used standard, and others include the Wireless Application Protocol (WAP), M-services, i-Mode and Web clipping.

The adoption of WAP builds on existing Internet standards and protocols adapted for use in wireless communication networks and addresses the unique characteristics of mobile wireless devices (with limited computing, memory, display, user interface, and power capabilities). WAP is a specification suite defining a set of protocols for presentation and delivery of wireless information and telephony services on mobile wireless devices. WAP services provide the information access and delivery to WAP-enabled devices. WAP was designed to empower users with easy and instant access to information and interactive services, allowing interoperability between WAP-enabled device through any WAP-compliant infrastructure to deliver timely information and accept transaction and queries.

WAP can be built on any operating system platform, including PalmOS, EPOC, Windows CE, FLEXOS, OS/9, JAVA, OS, etc. Being air interface independent, WAP is designed to be scalable to new networks as they develop, allowing bearer independence and development of common solutions across disparate networks.

The term “WAP” is commonly used to refer to the wireless application environment (WAE) although WAE includes the WAP suit of protocols and technologies. WAE provides the rich application environment which enables delivery of information and interactive services to mobile wireless devices. An important aspect of the WAE is the WAP stack, namely the wireless protocol layers. At the bottom of the WAP stack is a network layer, topped by the transport layer, the security layer, the transaction layer, and the session layer. Briefly, the network protocol layer supports network interface definitions, governing interface with the networks of wireless service providers (wireless bearers) such as short message service (SMS), code division multiple access (CDMA), cellular digital packet data (CDPD), general packet radio service (GPRS), high speed circuit-switched data (HSCSD), third generation (3G), GSM (global system for mobile communications), and unstructured supplementary service data (USSD) channel. The wireless transport layer supports the wireless datagram protocol (WDP), and when operating over an IP (Internet protocol) network layer WDP is replaced with user datagram protocol/IP (UDP/IP). WDP offers to the upper protocol layers a datagram service and transparent communication over the underlying bearer services. In other words, WDP offers to the upper protocol layers a common interface to and ability to function independent of the type of bearer wireless network. The wireless transport layer security (WTLS) provides a secure transport service to preserve the privacy, authentication and data integrity of the transport service at the layer below, as well as the ability to create and terminate secure connections between communicating applications. The transaction protocol (WTP) layer provides transaction oriented protocol for the WAP datagram service, including, for example, request-response transactions. The wireless session protocol (WSP) layer provides HTTP/1.1 functionality and features such as session suspend/resume. The WSP provides the upper-level application lever of the WAE with an interface to connection and connectionless services operating above the transaction protocol and the datagram transport layers, respectively.

The WAE (i.e., the wireless application environment) is further fashioned with a wireless markup language (WML) micro-browser, a WML script virtual machine, a WML script standard library, a wireless telephony application interface (TAI), and WAP content types. The WAP micro-browser, also referred to as the “WAP browser,” facilitates interaction between WAP/Web applications and WAP-enabled devices. The micro-browser is a tag-based wireless browser application supporting wireless markup language (WML), and extensible transport hyperlink markup language (XTHML). The micro-browser uses the “card” metaphor for user interface, where user interactions are split into cards. The WAP card metaphor provides a common interface to which all applications can conform, much like the desktop metaphor in PCs. The micro-browser supports user actions, defined at tree levels (deck, card, and select & link options, i.e., ACCEPT, PREV, etc.) and default tasks (PREV, NOOP, etc.). For example, a deck of cards is split into a navigation card, variables card, and input elements card. A navigation card is formed as a script encapsulated with the ‘card’ tags. The following example of a card includes the type of interaction (DO TYPE=“ACCEPT”) and link (GO URL=“#eCARD”).

```
<CARD>
    <DO TYPE=”ACCEPT”>
    <GO URL=”#eCARD”/>
    </DO
    WELCOME!
</CARD>
```

Both, PC-based browsers (such as Internet Explorer™ and Netscape Navigator™) and mobile device-based browsers, such as WAP browsers, have the concept of a “back” action implemented to enhance the ability of a user to navigate their previously viewed pages (cards). Invocation of the “back” action in a browser environment involves selection of ‘back’ on the browser tool bar or an equivalent thereof; and the “back” action returns the user to a previous URL. However, although on most wireless mobile devices, particularly phones, there is a ‘back’ button, it is presently not utilized.

In particular, to define the native functionality and features of a wireless mobile device, the J2ME™ platform includes a set of standard definitions for specifying the device configuration and profile (Sun Microsystems, Inc. Java™ 2 platform, Micro Edition). However, J2ME™ does not cover every desirable feature, and currently J2ME™ has no concept of “back” in any of the standard definitions for specifying such native functionality and profile. In the absence of this concept the ‘back’ button is useless.

### SUMMARY

The present invention is based, in part, on the observation that a need exists for such functionality and that the ‘back’ button functionality can be achieved as described below without dependency on the platform. Accordingly, the “back” concept is implemented in the context of a mobile application so as to allow use of the ‘back’ button.

For the purpose of this invention, the ‘back’ button, a voice or touch-activated ‘back’ command input, includes a button or a soft key. In further accordance with the purpose of the invention, as embodied and broadly described herein, a method, a mobile device, a computerized mobile system, and a wireless system with mobile devices, are proposed as possible implementations of the “back” concept. The various implementations involve ‘back’ logic implemented in the context of a mobile application.

Essentially, a mobile application having its own user interface logic provides a user interface experience outside the browser environment, and thus the user interface logic implementation is in effect platform-independent. As the ‘back’ logic is implemented in the context of a mobile application and provides a user interface experience outside the browser environment, it is likewise platform independent.

Specifically, in making use of the ‘back’ logic, a method for backwards navigation on a mobile device with command input and a state stack, includes a number of steps for traversing back from a current state. The current state is a screen, page or other state of the mobile application. Traversing back from a current state includes invoking the platform-independent ‘back’ logic and detecting a ‘back’ command from the touch activated command input. The platform-independent ‘back’ logic is responsive to the ‘back’ command input. Thus, in response to the ‘back’ command, a state is popped out from the state stack. The popped out state replaces the current state as the new current state. The method further includes generating a run-time environment in the mobile device for the new current state, and displaying a screen associated with the new current state along with a user interface to other states.

The run-time environment in the mobile device is provided for a client application, such as the client-side Yahoo!Photos, that is downloaded into the mobile device, and its associated ‘back’ logic is responsive to the ‘back’ command input. The platform-independent ‘back’ logic in the client mobile photos application provides for forward and backwards navigation through states corresponding to screens associated with mobile and online albums of photos.

The backwards navigation is conducted either in a back in sequence mode or in a back a level mode. In the back in sequence mode, the state stack holds a sequential state path that records a sequential forward flow through each state up to the current state, and the popped out state is a last-in state removed from the top of the state stack. Further in the back in sequence mode, the forward flow is recorded in a state history stack for future restoration of user interactions. In the back a level mode, the state stack holds a hierarchical state path, and the popped out state is a parent state removed from the top of the state stack. This path records parent states in a forward flow up to the current state, such that the backwards navigation follows, in reverse, the hierarchical state path.

According to one design approach, the mobile device is operative as a mobile computerized system controlled by a particular program. Such computerized system includes particular program code to implement the method as described above.

Then, in one embodiment, a mobile device, includes the touch-activated ‘back’ command input, a touch-activated ‘menu’ command input and a memory for storing a mobile client application. Note that a command input can be implemented as voice-activated, touch-activate, or any other suitable command input (but, without limiting the scope of the present invention, for simplicity we refer most often to the touch-activated command input). The mobile device is responsive to the touch-activated ‘menu’ command input for activating the mobile client application which is, in turn, responsive to the touch activated ‘back’ command input by providing backwards navigation through screens in ‘back in sequence’ mode or ‘back a level’ mode. As mentioned, the ‘back’ logic implemented in the context of the mobile application and responsible for the backwards navigation (outside the browser environment) is platform-independent. The mobile device further includes a display and menu selection capability. The display has resolution for text and graphic display, including display of a menu screen associated with the touch-activated ‘menu’ command input; and the touch-activated selection command input is for selecting a menu item from the menu screen or an action or menu item from another screen. The touch-activated ‘menu’ command and selection command inputs are operative to allow forward flow of screens. A state stack in the mobile device is for recording the forward flow either sequentially or hierarchically, thereby facilitating the backwards navigation. A state path stack in the mobile device is for recording the forward flow for future restoration of user interaction.

Typically, the functionality and profile of each mobile device are implemented using a Java 2 Micro Edition (J2ME™) platform. The functionality and profile of the mobile device includes hardware and software elements designed to recognize the indicia of activating a touch activated command input. For example, the software and hardware components, including the button or soft key, provide the function of a touch-activated ‘back’ command input and means for detecting indicia of activating this command input.

In one instance, the mobile device is operative as a wireless, mobile camera phone capable of capturing images and uploading the captured images to a server via a bearer network and the internet. In this configuration, the mobile device is wireless application protocol-compliant.

Thus, the wireless system includes, wireless mobile devices, a carrier network, a network including at least the Internet, and a server. The mobile devices are interconnected with the server via the carrier network and the network and are capable of communicating with each other via the server. In the wireless system, one or more than one mobile device has the touch-activated ‘back’ command input and a memory for receiving a mobile client application from the server wherein the mobile client application is responsive to the touch-activated ‘back’ command input by providing backwards navigation through screens in ‘back in sequence’ mode or ‘back a level’ mode. In the wireless system, a carrier gateway is typically disposed between the carrier network and the network. The carrier gateway is provided for tracking subscriber activities and controlling their data communications, as well as, for functioning as a proxy for the mobile devices, on one hand, and for the server, on the other hand.

As can be understood from these examples, by introducing the “back” functionality, the present invention makes the ‘back’ button useful and, to a limited degree, able to mimic the PC-based browser's back action functionality. This imitation, however, is only in form as the ‘back’ function in the context of the mobile application is separate and apart from and functioning differently from the back function in the browser environment. The advantages of the “back” functionality will be appreciated by those of ordinary skill in the art from the description and practice of the invention disclosed herein.

### BRIEF DESCRIPTION OF THE DRAWINGS

The accompanying drawings, which are incorporated in and constitute a part of this specification, illustrate embodiments of the invention and together with the description serve to explain the principles of the invention. Wherever convenient, same or similar numbers or designations are used throughout the drawings to refer to the same or like elements.

FIG. 1 shows a wireless interconnection model using one of the many types of available bearer networks.

FIG. 1A shows another model of interaction, via bearer networks, between 3^{rd}-generation (3G)-enabled mobile devices and servers as well as other devices.

FIG. 2 shows a mobile phone with features associated with the present invention.

FIG. 3 illustrates the flow once users reach the Yahoo!Photos landing page.

FIGS. 4A-4D show the respective PC-based and mobile device-based registration and application buy flow diagrams.

FIG. 5 shows the upload opt-in process.

FIGS. 6A and 6B show the screen flows for online albums and mobile albums, respectively.

FIG. 6C, parts (i) and (ii), describes setting up favorites for the mobile album slideshow.

FIG. 6D shows flow diagrams for photos view, share and save.

FIG. 6E illustrates the flow of restoring the mobile album from the server backup.

FIG. 7 provides a simplified diagram to illustrate the back button feature.

FIGS. 8A and 8B illustrate the user experience resulting from activating the ‘back’ button.

FIGS. 9A and 9B illustrate the architecture and functionality of the “back” feature.

### DETAILED DESCRIPTION OF THE INVENTION

The present invention relates to mobile applications, such as the Yahoo!Photos™ application, that implement the concept of “back action” with ‘back’ logic responsive to the ‘back’ button. Yahoo! and Yahoo! Photos are trademarks of Yahoo! Inc., Sunnyvale, Calif. Any other trademarks are the property of their respective holders.

The approach contemplated by the present invention can be implemented in any mobile application, but, for clarity and for illustration, it is described here in the context of a client-side Yahoo!Photos application and its interaction with the server-side Yahoo!Photos application. The server side of this program is the “server Yahoo!Photos,” and the client side of this program is the mobile client application, or “client Yahoo!Photos.” A “client” is generally considered to be a downloadable application, namely J2ME™, Yahoo!Photos, and other applications that are downloadable to the mobile device. In this particular example, the client Yahoo!Photos runs on a mobile phone, and more specifically, a mobile camera phone.

The Wireless Communication Environment

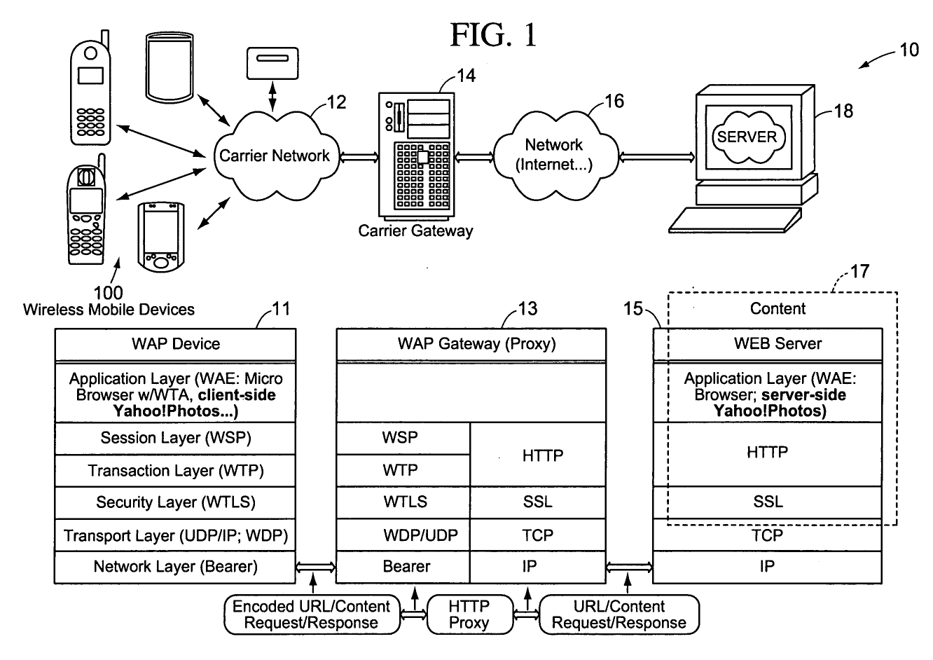

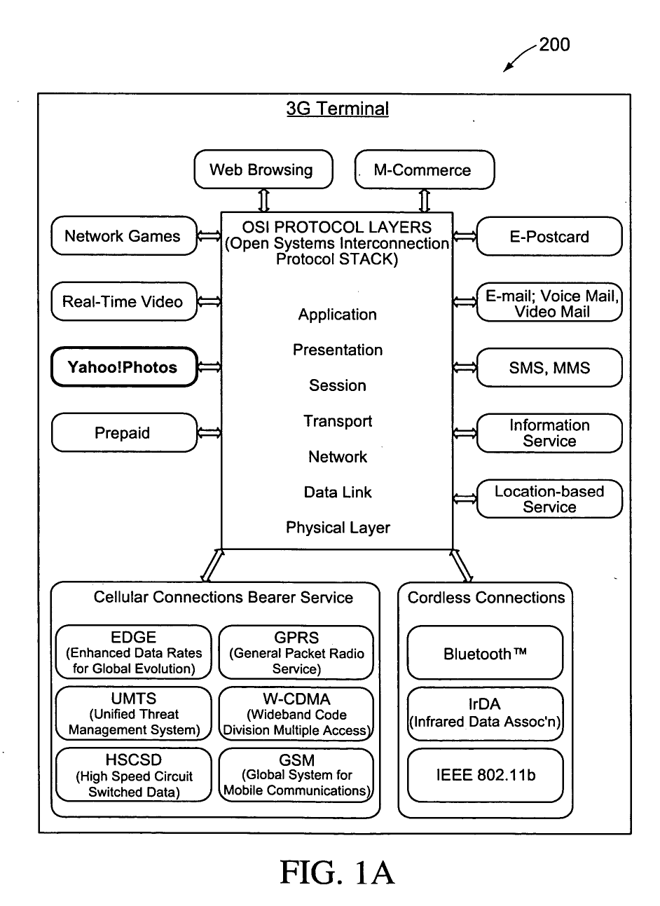

FIG. 1 shows a wireless interconnection model 10 using one of the many types of available bearer networks 12. The illustrated wireless mobile devices 100 are presumed to have sufficient local memory and Internet access capability to allow a user to download programs from servers 18 through the Internet 16 (and any other network such as LAN, WAN or Ethernet network) and store them in the local memory. Thus, wireless subscribers can gain fast access to content in these or other servers via the Internet through various downloadable applications. Note that the illustrated server 18 can be the origin of downloadable programs as well as the origin, or destination, of content; although programs and content can originate at or be destined for different servers. For the purpose of this illustration, the web server 18 is the source of the Yahoo!Photos client side application as well as the source, and destination, of content, particularly photos (image data). Using the downloaded program, such as Yahoo!Photos, and with multimedia capabilities, including the ability to retrieve e-mail, and push and pull information via the Internet, network operators (or, more generally, service providers) add value propositions beyond voice or text offerings.

In this example, the mobile phone used to download the Yahoo!Photos client side program is WAP-enabled. As shown in FIG. 1, the WAP-enabled device supports the WAP protocol and the server typically supports the WWW (world-wide web) protocol. In particular, the wireless application environment at the mobile device side includes the micro-browser, a suite of WAP protocols at the network through session layers, and the downloadable (client-side) Yahoo!Photos application program with the ‘back’ logic. The micro-browser defines how WML documents and WML script applets should be interpreted and presented to the mobile device user. The Micro-browser's WTA (wireless telephone application) functionality provides call control, phone book access and messaging within WML script applets to allow selective call forwarding or other secure telephony. The wireless application environment at the server includes the server-side Yahoo!Photos in addition to a standard web browser and WWW protocol stack (HTTP and TCP/IP).

Enabling web-based access to content, service providers deploy wireless data through the carrier network while controlling the data communications to their subscribers and tracking the billable activity. Typically, the gateway 14 is tasked with tracking subscriber activities, controlling access and, in addition, functioning as the proxy for the mobile device 100, on the one hand, and for the server 20, on the other hand. The gateway 14 is implemented, building on standard web proxy technology, to interconnect the services offered by the wireless service providers to the HTTP protocol so as to permit access to content on the wired Internet.

One model of interaction between a WAP-enabled device, the WAP-enabled proxy/gateway and the server, is the Hypertext Transfer Protocol (HTTP) 1.1 response/request transaction, where HTTP 1.1 is profiled for the wireless environment. The gateway translates requests from the WAP protocol to the WWW protocol, and vice versa; translating WML(/HTML) documents to HTML(/WML), resolving domain names in URLs and providing a control point for managing access. From the WAP-enabled gateway with encoders/decoders, the URL requests or WML documents (possibly in encoded form) can be sent encoded/decoded to add security to the user interaction. Note that, unlike the flat structure of HTML documents, WML documents are divided into a set of user interaction units, namely a deck of cards. Each user interaction unit is a card (or page), and the user can navigate between cards in one or more WML documents.

Another model of interaction between a WAP-enabled device, the WAP-enabled proxy/gateway, and the server, is the HTTP response/request transaction (protocol running on top of the Internet's TCP/IP suite of protocols). This model is appropriate for the newer WAP 2.0 (with protocol stack not shown in FIG. 1). Unlike the above-mentioned, and illustrated, WAP stack, WAP 2.0 stack includes the IP, TCP (transmission control protocol), TLS, HTTP and WAE layers atop the network layer (all of which are profiled for wireless environment). For example, the wireless profile for the TLS protocol will permit interoperability for secure transactions.

Yet another model of interaction via bearer networks, between 3^{rd}-generation (3G)-enabled mobile devices and servers or other devices, is shown in FIG. 1A. As shown, a 3G terminal supports higher-speed, wider-band wireless cellular service communications based on various technologies, including wide code division multiple access (W-CDMA), general packet radio service (GPRS), global system for mobile communications (GSM), enhanced data rates for global evolution (EDGE), unified threat management system (UMTS), and high speed circuit switched data (HSCSD). A 3G terminal is equipped with cordless connections for local, short distance communications. The communication protocols in the 3G terminal are comparable to the open system interconnection (OSI) protocols, layered in the OSI stack. Various services are supported by these protocols, including web browsing, short message service (SMS), multimedia messaging service (MMS), e-mail, M-commerce, real-time video, and pre-paid. The MMS, for example, is a store and forward messaging service capable of adding multimedia elements to SMS, including images, text, audio clips, and video clips. MMS is synchronized across a common timeline, rather than being discrete like e-mail and SMS; it is akin to a presentation layer over e-mail and looking like a slide show with images. On a compatible phone, the MMS message will appear with a new message alert. The picture message will open on the screen, the text will appear below the image and the sound will begin to play automatically.

Downloadable applications such as Yahoo!Photos and network games are likewise supported in the 3G terminal and interact with services such as MMS. The originator can easily create a multimedia message, either using a built-in or accessory camera, or can use images and sounds stored previously in the phone (and possibly downloaded from a web site). However, for simplicity, the following description assumes that the mobile device is a WAP-enabled camera phone used for downloading photo applications such as the Yahoo!Photos.

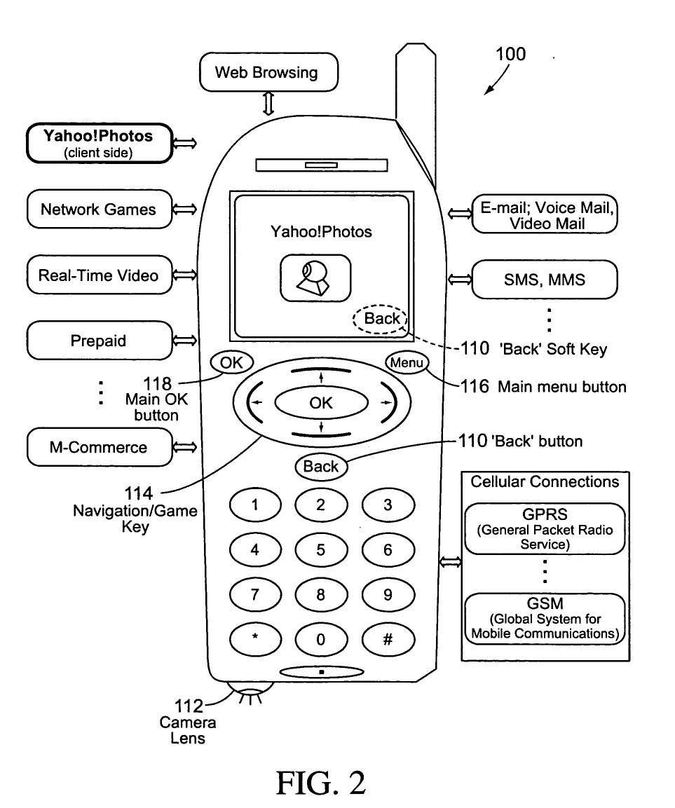

FIG. 2 shows a mobile phone 100, not necessarily associated with any particular manufacturer, but with features associated with the present invention. The device functionality is implemented preferably using the J2ME™ platform which is tailored for a broad range of embedded devices such as mobile phones. The J2ME™ platform includes a set of standard Java APIs (application programming Interface), and provides a user interface, a security model, built-in network protocols (e.g., WAP, as shown in FIG. 1), and support for networked and disconnected applications (Yahoo!Photos is a networked application).

With J2ME™, applications are written once for a wide range of devices. Applications leveraging each device's native capabilities are then downloaded dynamically. The J2ME™ platform defines configurations, profiles and optional packages as elements for building complete Java run time environments. Configurations are composed of a virtual machine and a minimal set of class libraries and provide the base functionality for a particular range of devices that share similar characteristics. Current configurations include connected limited device configuration (CLDC) for devices with limited memory and processing capabilities (e.g., mobile phones, two-way pagers, and PDAs) and connected device configuration (CDC) for devices with better memory, processing and network bandwidth capabilities (e.g., TV set-top boxes, residential gateways, in-vehicle telematics systems, and hi-end PDAs). However, in order to provide a complete runtime environment targeted at specific device categories, the configurations must be combined with a set of the high-level APIs, or profiles, that further define the application life cycle model, access to device-specific properties, and user interface.

One example of profiles is the mobile information device profile (MIDP) which is designed for mobile phones and entry-level PDAs. MIDP offers a core application functionality required by mobile applications, including user interface, network connectivity, local data storage, and application management. The J2ME™ can be further extended by combining various optional packages and their corresponding profiles to address specific market requirements, e.g., Bluetooth™, web services, wireless messaging, multimedia, and database connectivity.

The Back Button in the Context of Mobile Yahoo!Photos

As indicated before, although it allows a complete runtime environment the J2ME™ platform does not include profiles for every desirable feature. Specifically, standard PC-based and wireless mobile-based browsers (e.g. WAP browser or micro-browser) have the “back” navigation feature, and mobile phones are physically equipped with the ‘back’ button, but the ‘back’ button is inactive. This is because in J2ME™ specifications there is no standard definition for specifying a feature resembling the “back” functionality with a ‘back’ button.

Accordingly, one desired feature that Yahoo!-enabled devices have is the “back” feature, and various embodiments of the present invention relate to this feature. In the context of Yahoo!Photos, the ‘back’ button functionality includes two modes: 1) back a level, and 2) back in sequence. Although, theoretically this functionality overrides the current functionality of the ‘back’ button, in reality, this button is currently inactive.

As described in more detail below, Yahoo!-enabled devices are operative for downloading, via a link, and supporting the Yahoo!Photos application. In Yahoo!-enabled devices, the link is provided as a feature of the device, for instance as part of the main page. Moreover, in Yahoo!-enabled devices the “back” functionality attributed to the ‘back’ button resembles in some ways but, because of the way it is deployed, is otherwise not the same as the “back” functionality of a web browser. More specifically, much like other mobile applications that implement the principles of the present invention, the Yahoo!Photos application has its own user interface. In other words, user interface functionality, including ‘back’ button functionality, is provided in the context of the Yahoo!Photos application, outside the browser environment. The ‘back’ logic for implementing the ‘back’ button functionality is deployed in the Yahoo!Photos application. Then, because Yahoo!Photos has its own user interface outside the web browser environment, and the back logic is deployed in the Yahoo!Photos application, the ‘back’ logic is platform independent. By comparison, browsers such as WAP browsers are platform dependent.

Note that the mobile device illustrated in FIG. 2 is a camera phone, but the principles of the present invention are not limited to camera phones. Any phone or other wireless mobile device can embody the present invention in one form or another. When the mobile device is a smart handset, downloading application programs and implementation of the “back button” feature are possible even though the communications with the service provider may be different in character.

In the context of Yahoo!Photos, as shown in FIG. 2, a mobile phone 100 has features associated with the present invention. For example, to accommodate the Yahoo!Photos application, the mobile phone 100 has a camera feature with the camera lens 112 exposed for capturing images. The mobile phone 100 also has a 5-point navigation key (also called game key) 114, and it features left, right, up, down and selection, or ‘OK,’ functions, substantially mimicking the operations of a mouse. The main menu button 116 activates the menu display on the screen, and the main OK button 118 activates a menu selection. The ‘back’ button 110 is shown as a hardware key whose position here is merely exemplary. Namely, the physical placement of the ‘back’ button is device dependent, where it is anticipated that buttons on different devices may be arranged differently. A ‘back’ soft-key is possible to implement a ‘back’ function of the client mobile application, which means that it would show up as an icon or menu item on the screen of the mobile phone. In other configurations, the ‘back’ button could be any touch or voice activated input.

It should be mentioned that, although the manufacturer provides the Yahoo!-enabled phone 100 with camera functionality—i.e., functionality for capturing images, and saving, displaying, manipulating, transmitting and receiving data of image—this camera functionality is independent from the Yahoo!Photos program. That is, data of the captured images reside in the mobile phone outside the Yahoo!Photos environment until such time that this data is introduced to the Yahoo!Photos environment by being first uploaded to the Yahoo! server and then downloaded to the local (mobile) Yahoo!Photos album, as will be later explained.

As further shown in FIG. 2, the Yahoo!-enabled phone 100 supports wireless cellular service communications based on various technologies such as general packet radio service (GPRS) and global system for mobile communications (GSM). This device is WAP-enabled, configured for supporting WAP communication protocols (at all layers of the WAP stack). Various services are supported by these protocols, including web browsing, SMS, MMS, e-mail, M-commerce, real-time video, and pre-paid. Downloadable programs designed to interact with such services include the network games and Yahoo!Photos.

On mobile devices, these programs are offered to the user on a default start-up or main menu screen or on a manufacturer-installed virtual vending machine screen. Other selection items include, for example, the menu item for setting the sound. These start up and vending screens show a menu with a list (or icons) of applications which the user can obtain by following an install procedure. The menu provides links to various service web sites, including, for example, the Yahoo!Photos site. The links, of course, are URLs (Uniform Resource Locator)—i.e., the world wide web address of a site on the Internet, and on the Yahoo!-enabled phone, at least one such menu item is the link for downloading the Yahoo!Photos application.

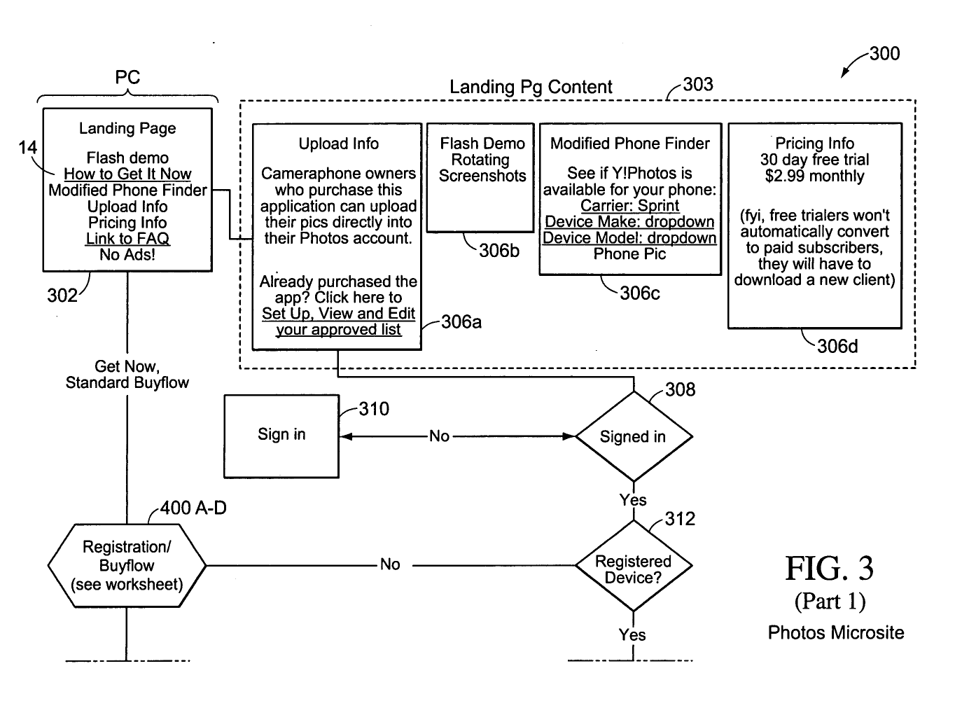

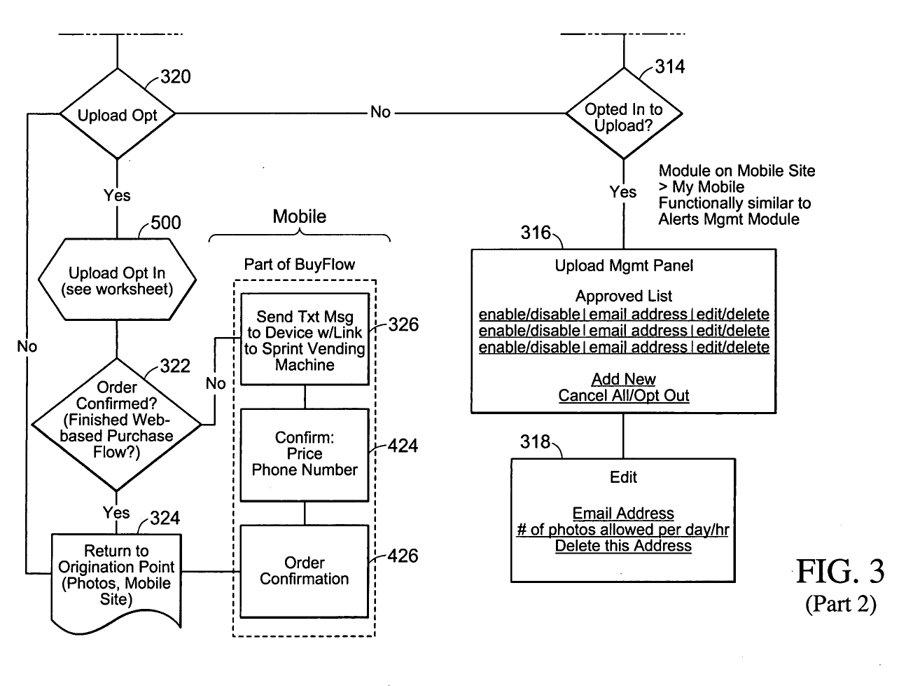

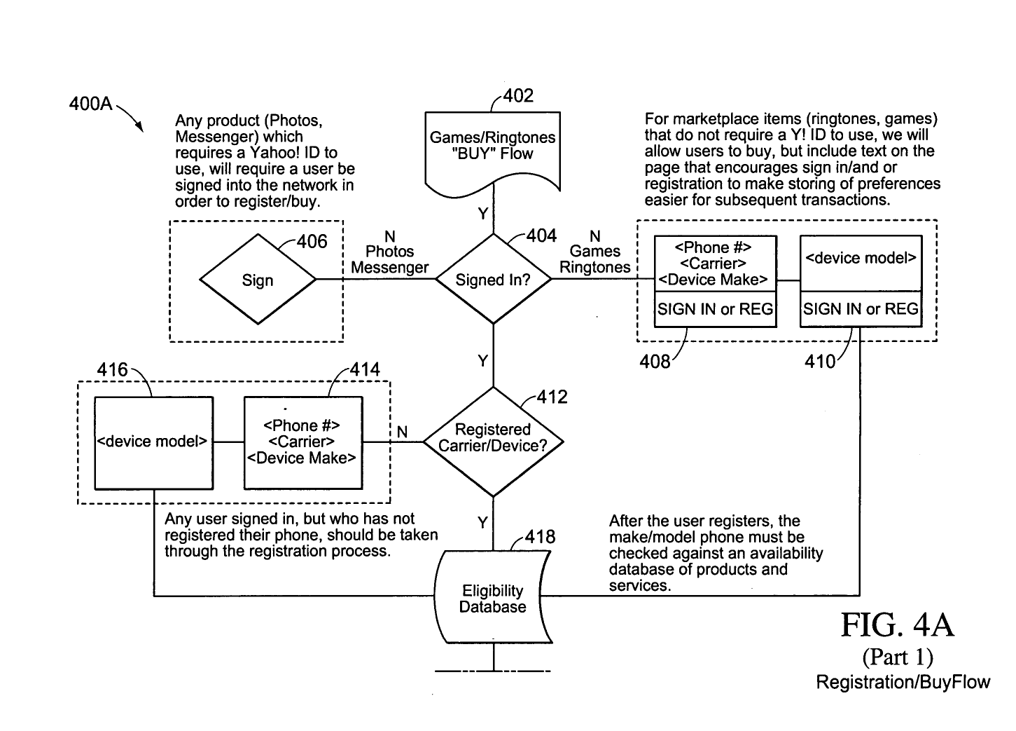

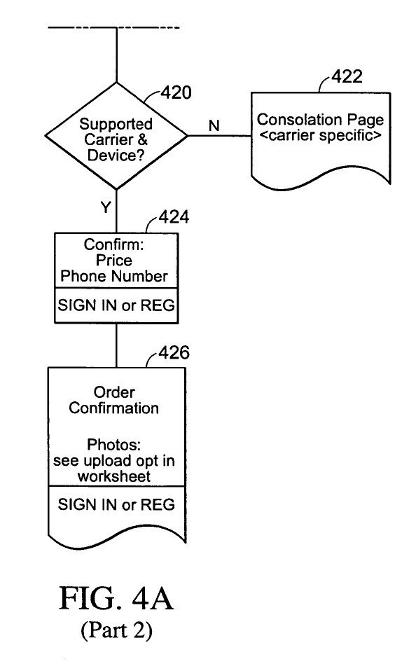

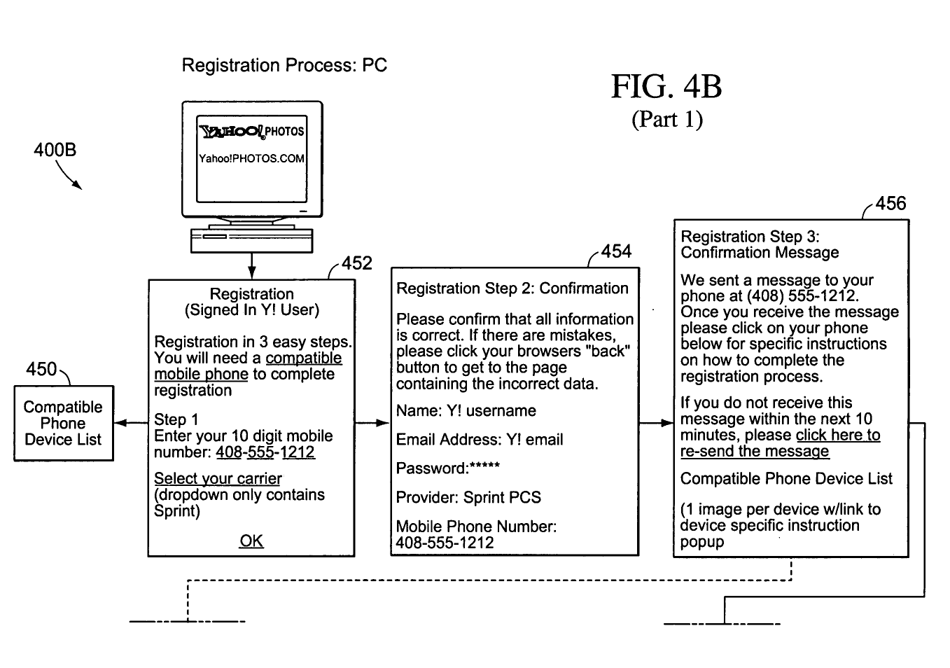

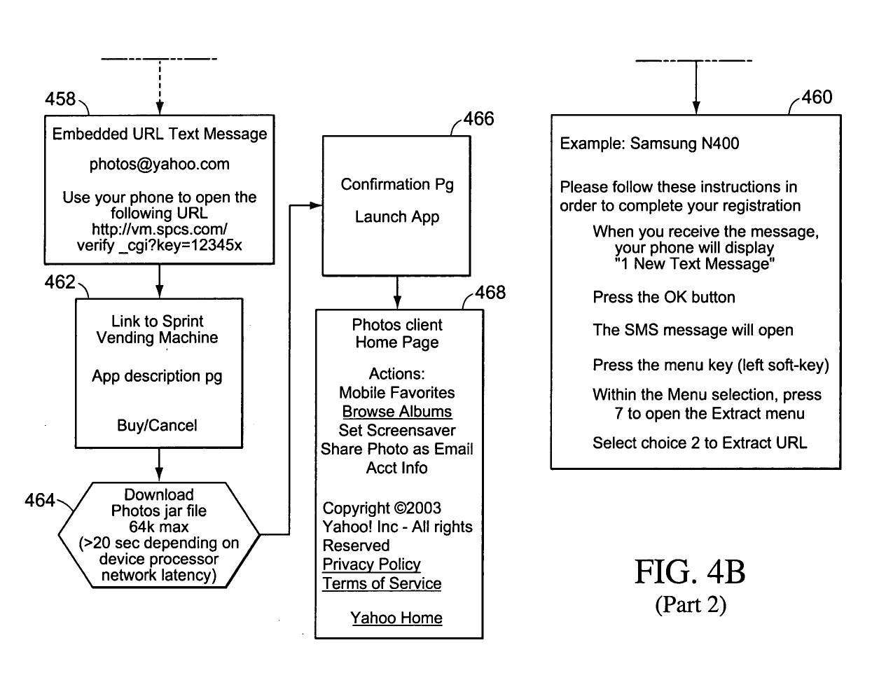

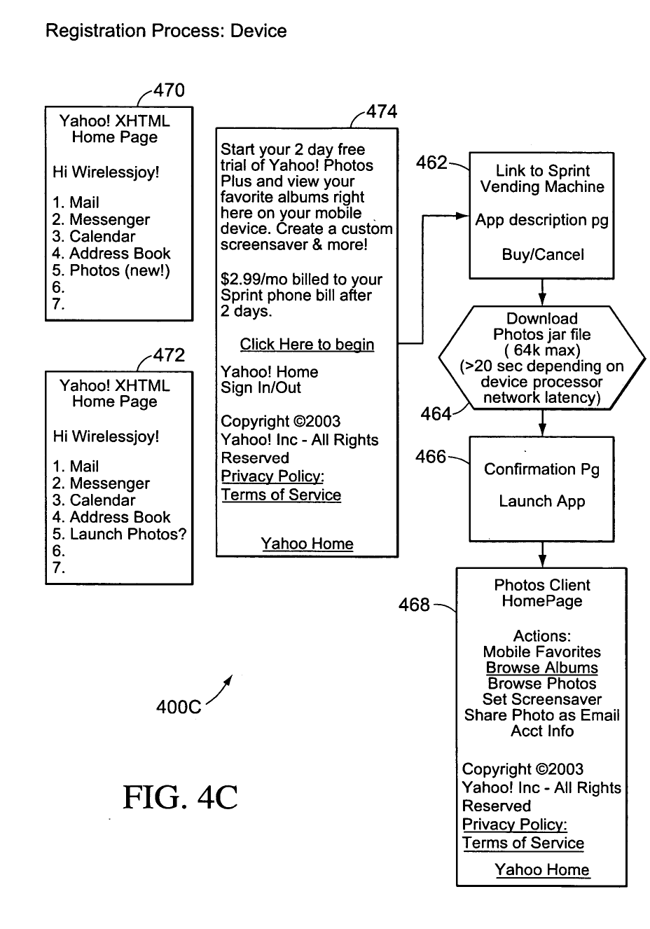

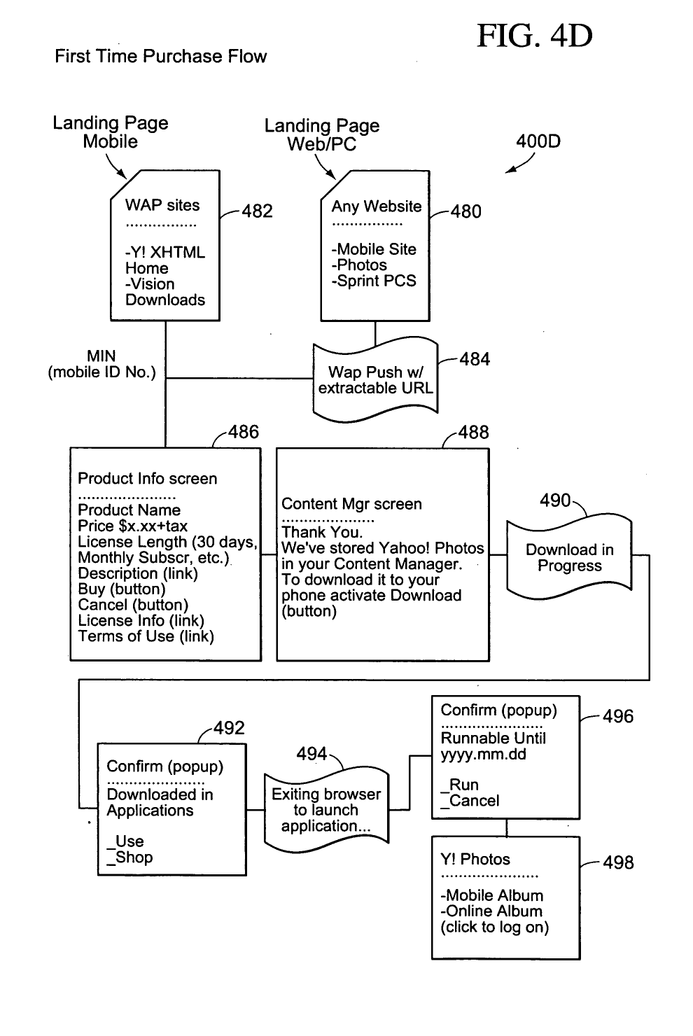

FIG. 3 illustrates the flow once users reach the mobile application site, which, in this example, is the Yahoo!Photos landing page. The URL for the landing page is obtained via a link from a promotional web page, through a web search, or from a bookmark (or favorites). The flow is shown as originating on a user's PC (personal computer) and it commences with program information presented at the landing page 302 on the PC display. The contents 303 and 304 of the landing page is presented to show the options available to the user based on whether or not the user has already purchased the Yahoo!Photos program. For instance, the landing page presents to the user the Yahoo!Photos program name with the option of “how to get it now” 304, as well as upload information 306a, flash demo 306b, and pricing information 306d, say, “$2.99 monthly.” To buy the application the user clicks on the application name, Yahoo!Photos, or on “how to get it now.” Subsequent to the registration 400_{A-D}, a query (such as “would you like to buy it for $2.99?”) prompts the user to accept/reject the offer 320, and then the user is prompted to establish upload opt-in parameters 500, as will be later explained. If the user accepts the offer to buy the application, the order is confirmed 322 and the application is downloaded into the mobile phone, becoming resident on the mobile phone. FIGS. 4A-4D show the respective PC-based and mobile-based registration and buy flow diagrams.

Incidentally, as shown in FIGS. 3 and 4A, if the user confirms acceptance, assuming the user has an account on the server having signed in before, the user is prompted to provide the telephone number of the mobile phone. With that phone number, the server sends a short message embedded with a link to the mobile phone and causes the mobile phone to vibrate or, otherwise, signals the user with a message requesting confirmation of the purchase 326. With this confirmation 426 the server proceeds to send the program to the mobile phone.

As shown in FIGS. 4B and 4C, registration can originate on the PC or the mobile phone. In the PC-based registration process, once, the compatible phone list is reviewed 450 and the phone is deemed compatible, registration can go forward starting with the user entering the 10-digit mobile phone number 452. The service provider dials the 10-digit phone number and requests confirmation from the user via that mobile phone 456. The user is also prompted to follow the buy instructions 460 or follow the link to the vending machine 458. Once the download takes place the Yahoo!Photos client home page 268 is presented on the mobile screen. Alternatively, rather than indirectly via the PC, a program such as Yahoo!Photos can be purchased directly via the mobile phone, as shown in FIG. 4C. That is, the registration process originating from the mobile phone is launched from the menu page, e.g. Yahoo! home pages 470 or 472. Beyond that, the link to (virtual) vendor machine page 462, download page 464, confirmation page 466 and home page 468 are similar to those in FIG. 4B.

FIG. 4D shows a first-time purchase flow. As can be seen, the purchase can originate either at the PC or the mobile phone, starting with the respective landing page. Note that in the PC-based process the landing page 480 is obtained via a standard browser. In the mobile-based process, the landing page 482 presents the WAP sites, assuming the mobile phone is WAP compliant and uses the micro-browser for linking to this and subsequent pages. Then, for a first time purchaser the product information (i.e. Yahoo!Photos application) is introduced along with price and links to terms of use and buy/cancel selection buttons (icons) 486. Download activation 488, progress update 490 and confirmation 492 are provided along the way when the application is loaded. The application is then ready to launch on exiting the micro-browser 494. After being invoked, the home page of Yahoo!Photos is displayed 498.

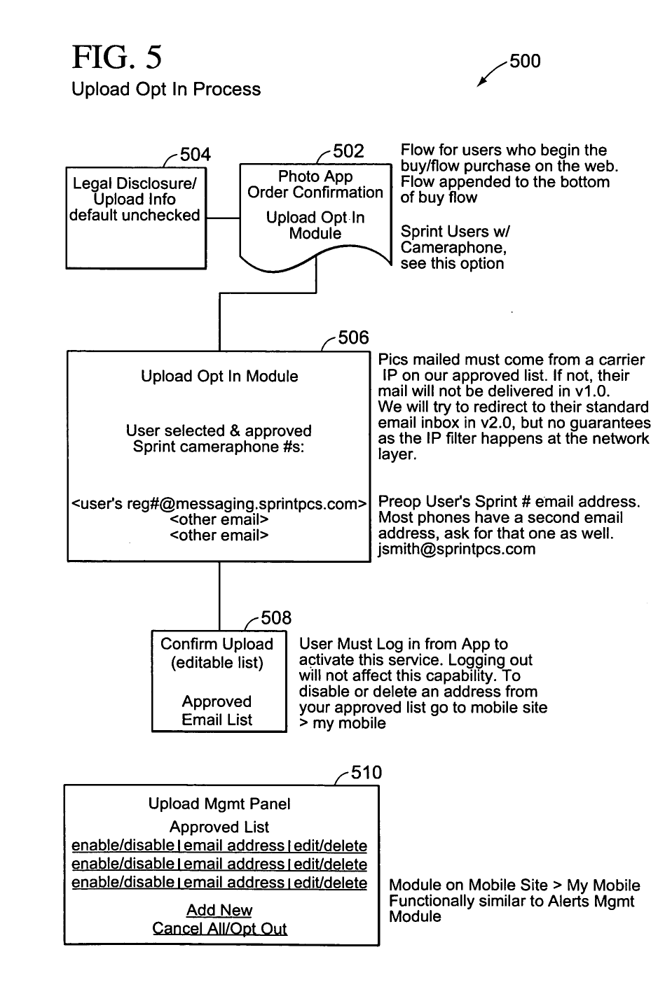

As mentioned above, the registration and buy process of FIG. 3 includes setting the upload opt-in 500 parameters. FIG. 5 shows the upload opt-in processes 500 for setting the user's upload parameters that establish the user's upload preferences (once the upload opt-in module is invoked 502). At the PC, the user enters the service provider-issued phone numbers of mobile phones authorized by the user to upload their photos to the user's Yahoo!Photo account (on the server) 506. The user additionally enters one or more of the user's e-mails, e.g., <user reg. #messaging.sprintPCS> or <jsmith@sprintpcs.com>, through which the photos are uploaded to the user account 506. The e-mails are posted on the approved list. Although it is not shown, the user can additionally pre-select the maximum number of upload messages the user wants to receive in a day (or any other predefined period of time). At the end of this selection process the user is prompted to confirm the entries 508 before they are stored in the database for future reference.

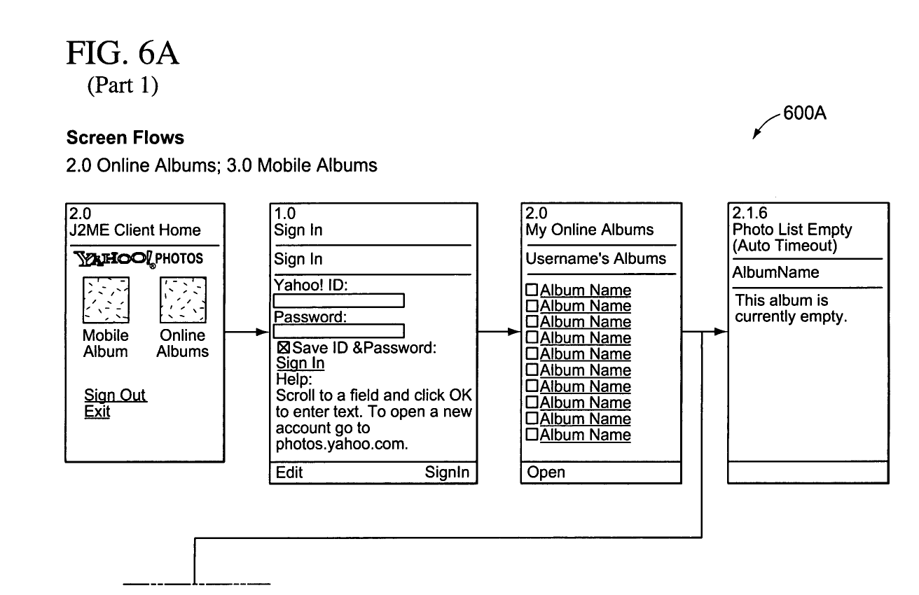

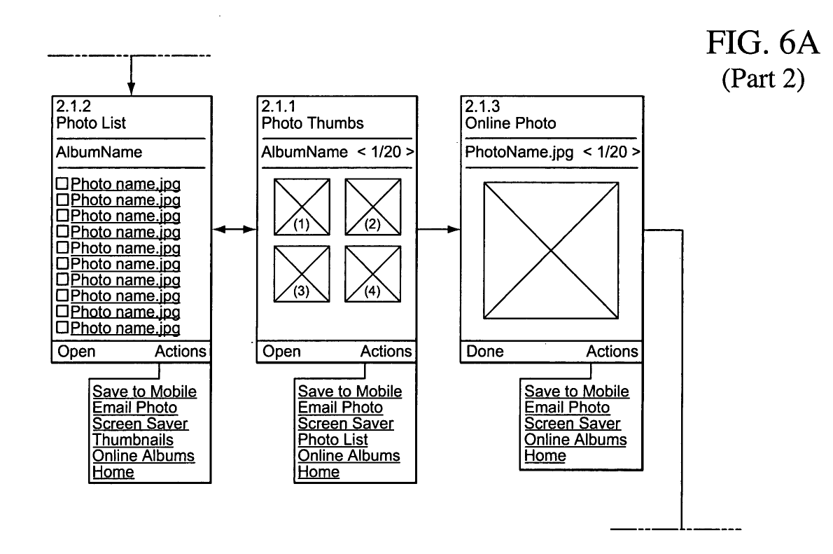

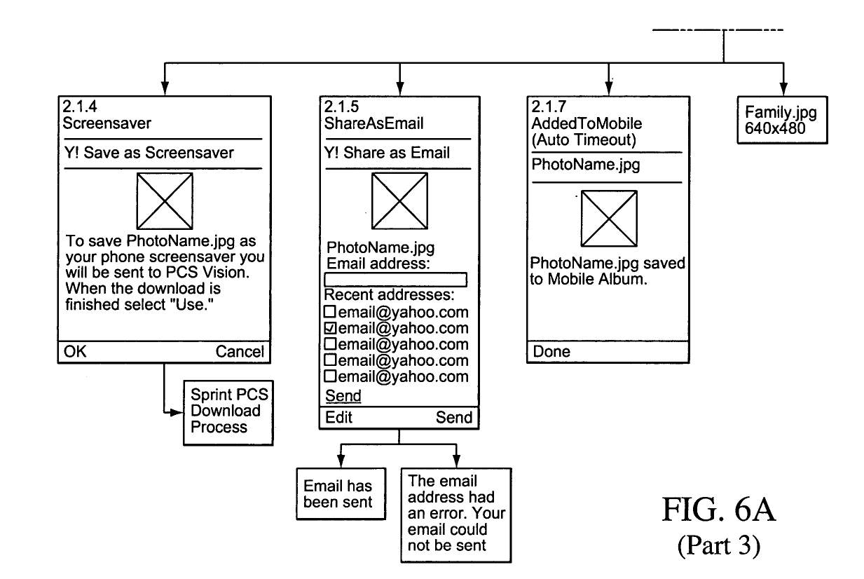

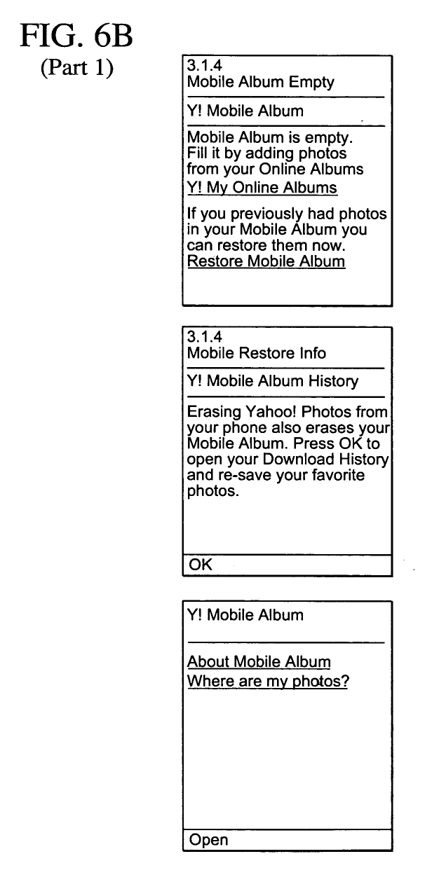

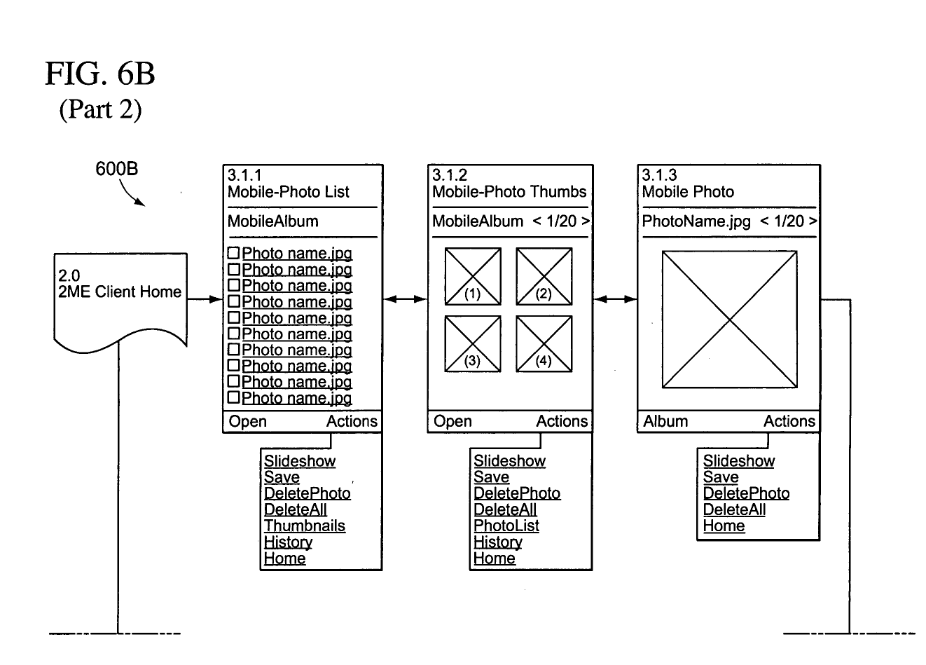

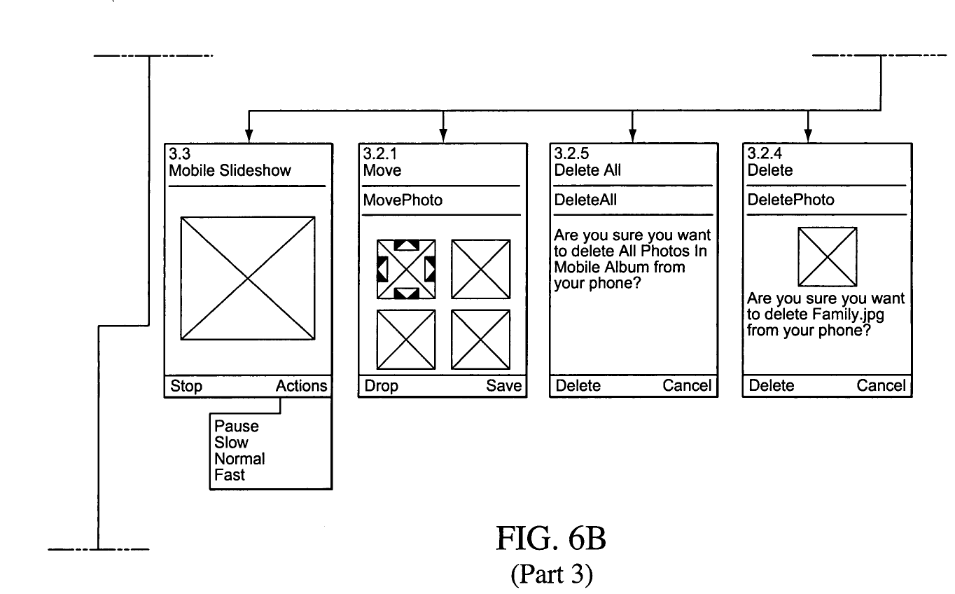

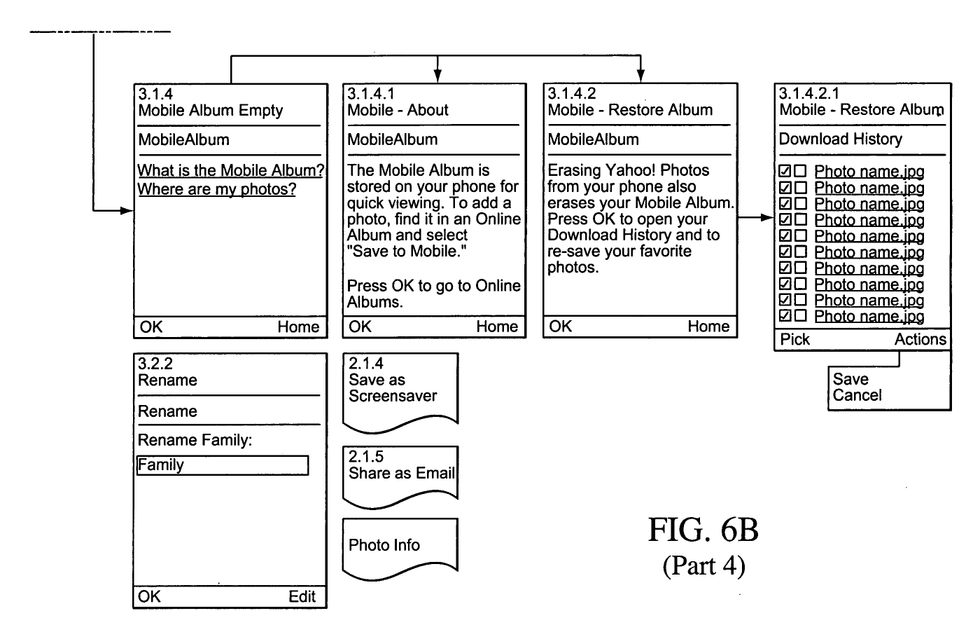

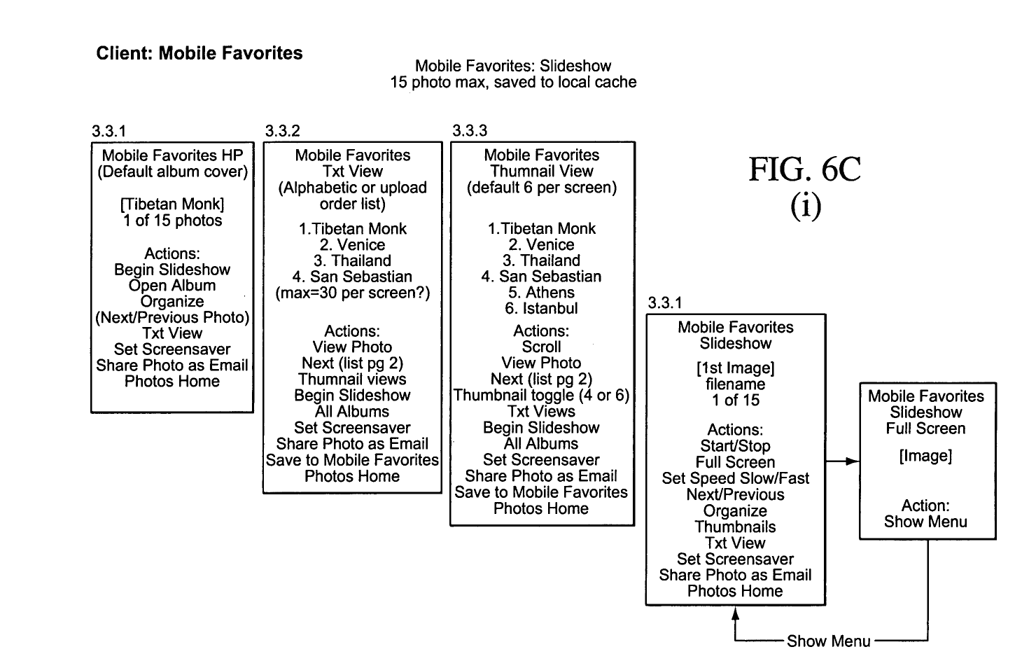

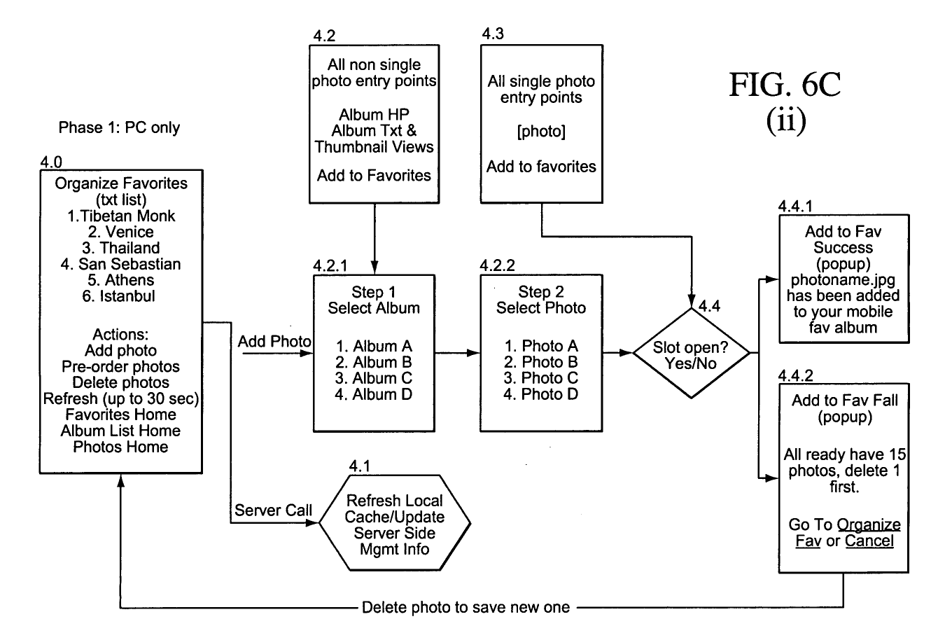

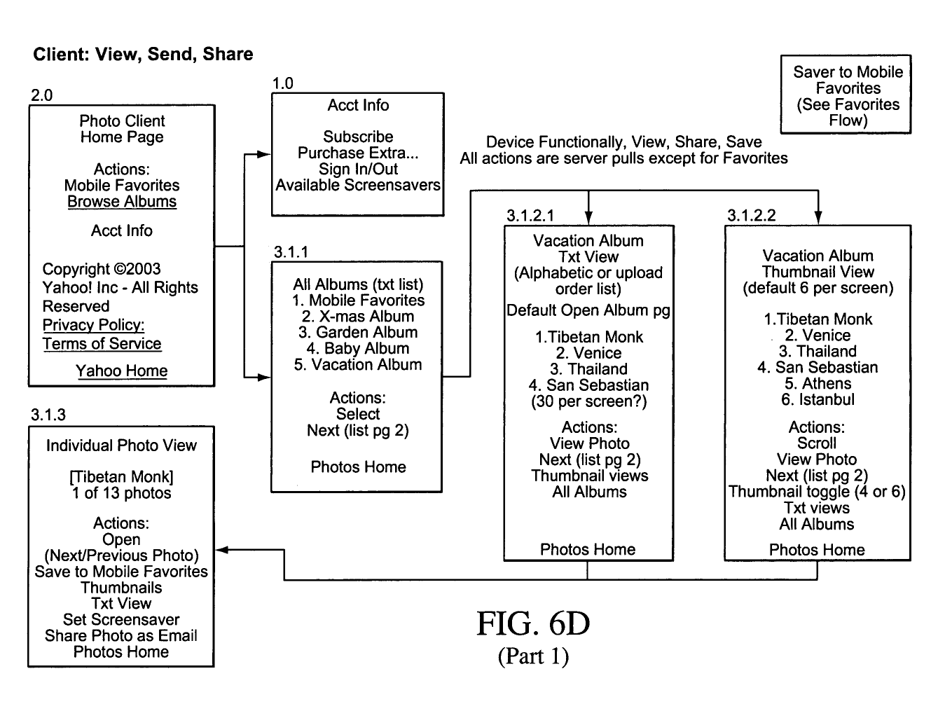

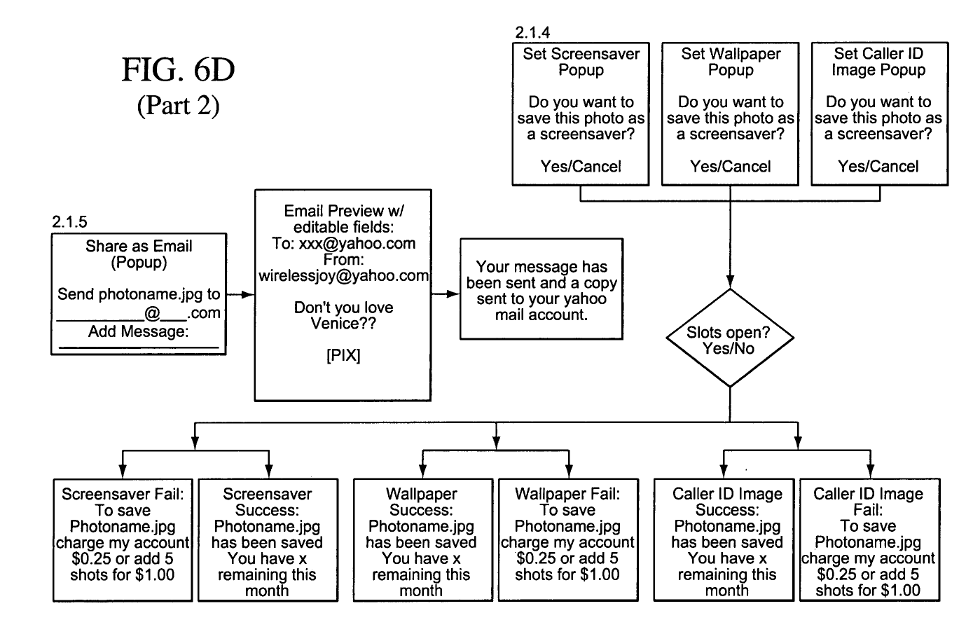

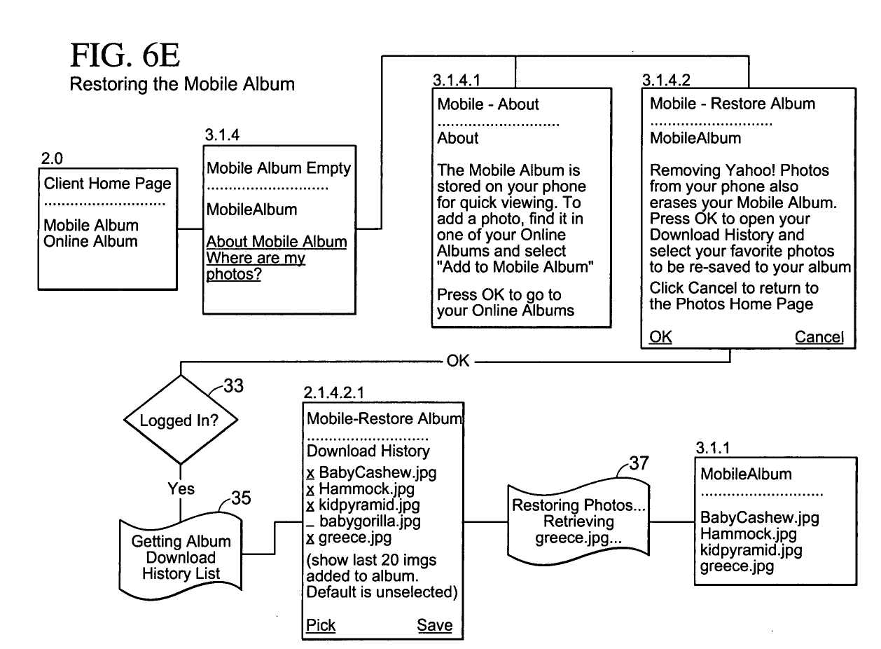

Once the Yahoo!Photos program is resident on the mobile phone it can be invoked from the landing page or menu page (using the menu button on the phone to bring up the menu or using the default menu if Yahoo!Photos is presented as one of the default menu options). Invocation of the Yahoo!Photos application allows, among others, user access and manipulation of the user's mobile album as well as online albums in the user account. FIGS. 6A and 6B show the screen flows for online albums and mobile albums, respectively.

Invocation of Yahoo!Photos prompts this program to display the ‘home’ page 2.0 with two main options: mobile album, and online album (as shown in FIGS. 6A and 6B). The mobile album is an album of photos stored locally on the mobile phone, so that the user need not go out over the network to obtain them. The online album is an album of photos stored on the server in the user's account. As mentioned before, photo images can be captured and manipulated by the mobile phone outside the Yahoo!Photos environment. These photo images will not be available at the mobile or online albums until they are uploaded to the server, stored in the online album and then (selectively or in batch) downloaded to the mobile album, and vice versa. Accordingly, selecting ‘online album’ allows the user to access and manipulate photo images that have already been uploaded to the server from the user's PC or mobile phone and stored in the online album. Likewise, selecting ‘mobile album’ allows the user to access and manipulate photo images that have been already downloaded from the server into the mobile album.

Then, if the ‘online album’ option is selected from the Yahoo!Photos client program ‘home’ page (2.0), as shown in FIG. 6A, it prompts the program to display the next page which is the ‘sign-in’ page (1.0). It requires the user to follow a sign-in procedure that typically includes providing a Yahoo!ID and user password. The sign-in procedure will, among others, bring up the user's account and relate it to the user's online albums. That is, the sign-in procedure allows the user to access his account via the Internet (and other proprietary network if applicable).

The next page is the ‘my online albums’ page (2.1). For the specific user, this online albums page lists the names of photo albums available to the named user which are associated with the user's account. Of course, only albums that are on the server are listed, and if the selected album is empty the next page will display an indication to that effect (i.e., “this album is currently empty” at page; 2.1.6). Alternatively, if the album is not empty, selecting that album will bring up the next page, the ‘photo list’ page for that album (2.1.2). In the ‘photo list’ page, a photo can be selected for downloading it from the server onto the mobile phone. Additionally, a selected photo can be opened or other actions can be invoked in relation to it. The other actions are presented in a menu that is shown on the screen as a pull-down menu, pop-up menu, or a menu superimposed on any part of the current page (in this example the menu is shown as a pull-down menu).

Such menu (hereafter “photo options menu”) provides a number of selection items, each of each representing an action, including: ‘save to mobile,’ ‘email phot,’ ‘screen saver,’ ‘thumbnails,’ ‘online albums,’ and ‘home.’ Each selection brings up a page that corresponds to the selected action item. Two of the action items have already been discussed above, ‘home’ and ‘online album.’ Selecting home, will lead the user back to the home page (2.0), and selecting online album, will lead the user to the aforementioned ‘my online albums’ page (2.1).

Selecting ‘thumbnails’ brings up a ‘photo thumbs’ page 2.1.1 that shows a group of thumbnail photo images from the selected album. Note that the number of photo thumb groups downloaded from the server depends on the memory size of the mobile phone (or whatever device is used). With this feature, the user can then thumbnail through the groups of photos in the album. The groups of thumbnail photo images in this album are each loaded from the server. The user can then move between the images back and forth (scroll back and forth) and select any one of the photos in the ‘thumbnails’ page. A selected thumbnail image will be enlarged in the next page, the ‘online photo’ page (2.1.3).

As can be seen, each of the pages, ‘photo list’ (2.1.2), ‘photo thumbs’ (2.1.1), and ‘online photo’ (2.1.3), includes the photo options menu feature. Among these action items, when ‘save to mobile’ is invoked from the ‘photo list’ page, ‘photo thumbs’ page, or ‘online photo’ page, it causes the selected photo image (previously downloaded from the server) to be saved in the mobile album on the mobile phone. The ‘added to mobile’ page (2.1.7) is brought up in this case to show the photo being saved and to give an indication that saving is done.

When ‘email photo’ action is invoked, the ‘share as email’ page comes up (2.1.5). This page shows the photo selected for emailing and prompts the user for the email address. In this implementation, a number of recently-used email addresses are provided. Incidentally, when the e-mail is sent from the mobile phone, a message pops up indicating that the email has been sent or, if not, that an error occurred.

When the ‘screen saver’ action is invoked, the selected photo will be used to populate the screen when the phone is idle, standing by, or starting up. The ‘screen saver’ option is associated with screen saver page (2.1.4) which shows the selected photo and requires the user to select ‘OK’ or ‘cancel’ to add this photo to the screen saver photo roster. A message pops up to indicate the status of the photo download.

Going back to the mobile album is possible with the photo options menu via the ‘home’ page, using the ‘home’ option as discussed above. Another way for getting to the mobile album or any other previous page is with the “back” action using the ‘back’ button, as will be later discussed in more detail. Also, as mentioned above, when the Yahoo!Photos application is invoked from the landing/menu page, the ‘home’ page (2.0) presents the ‘mobile album’ as one of the selection items. Accordingly, the mobile album can be directly accessed via the ‘home’ page.

The mobile album screen flow, shown in FIG. 6B, starts with the ‘home’ page (2.0) and selection of the mobile album brings up the ‘mobile photo’ list page (3.1. 1). This page presents two action menus, ‘open’ and ‘action.’ Thus, selection of any of the listed photos can be followed by selecting ‘open’ or ‘action.’ As before, when ‘open’ is selected the photo is shown on the screen in the ‘photo thumbs’ page (3.1.2). When ‘actions’ is selected, a mobile photo action menu is provided. This menu includes action items such as ‘slide show,’ ‘move,’ ‘delete photo,’ ‘delete all’ (photos), ‘thumbnails,’ ‘history,’ and ‘home.’

Except for the photos being local (at the mobile album), the thumbnails feature, associated with the ‘photo thumbs’ page (3.1.2), works as described above with reference to the online album. A photo selected on the mobile ‘photo thumbs’ page can be enlarged as shown in the next page, the ‘mobile photo’ page (3.1.3). The menu for the ‘photo thumbs’ and ‘mobile photo’ pages includes a subset of the aforementioned mobile photo action menu.

When the slide show is invoked from such a menu the ‘mobile slide show’ page comes up (3.3). While this feature is active, the slide show will scroll through the mobile album photos, showing each photo for a certain period. The slide show will go on until the user selects ‘stop’ on the bottom of the page. If the user selects ‘actions’ a slide show menu gives the user the options of ‘pause,’ ‘show,’ ‘normal,’ and ‘fast.’ The ‘pause’ option is selected for pausing the slide show; ‘slow’ will slow down the slide show, ‘speed’ will speed up the slide show, and ‘normal’ will bring it to normal speed. (FIG. 6C, parts (i) and (ii), describes setting up favorites for the mobile album slideshow; part (i) describes the process in the mobile device, and part (ii) describes the process originating at the PC).

As further shown in FIG. 6B, the ‘move’ page comes up (3.2.1) when the move’ action (referred to also as ‘rearrange’ action) is selected from any one of the three pages (3.1.1, 3.1.2 and 3.1.3). In this page, the program displays a group of photos (thumbnails) and the user can rearrange the photos using the 5-point navigation key, as well as choose to drop a photo or save it (FIG. 6D shows flow diagrams for photos view, share and save). When the ‘delete’ or ‘delete all’ actions are selected, the user has the option of deleting or canceling the delete action (as shown in pages 3.2.5 and 3.2.4). The ‘delete’ page shows the photo selected for deletion to allow the user to change their mind. When all the photos are deleted, or when the mobile album is empty to begin with, the ‘mobile album empty’ page is displayed (3.1.4). It allows the user to select the home page or select the answer to any one of the queries, such as “where are my photos?” and “what is the mobile album?.” Selection of the latter will bring up the ‘about’ page (3.1.4.1), and in this page pressing ‘OK’ provides user access to the online album(s). Selection of the former brings up the ‘restore album’ page 3.1.4.2. The “restore” function is explained in more detail below.

Note that, when the user signs in, the server associates the user's identification with his historical record so that the application program can record (backup) the photo in the server each time the user saves a photo to the mobile album. This historical record serves as a backup that allows the user to restore his album if the Yahoo!Photos program is erased, for any reason, from the mobile phone memory and the user then reloads this program. This history feature is useful to reduce the navigation for restoring the mobile album since the server maintains this information in the user's client account.

It is important to note that although the history feature is described in the context of the Yahoo!Photos program, it is useful in any mobile device application where backup is desired. Thus, although this feature is implemented for the Yahoo!Photos application, it can be implemented more generically for other applications.

In the Yahoo!Photos context, every photo from the user's online album that is saved to the mobile album is ‘remembered’ by the server. Preferably, since the page traversal path is not predictive the history is recorded accurately and fully. This is made possible with the association of the user's Yahoo!ID to a user's historical record on the server that records all photos saved by the user to the mobile album. Moreover, since each mobile phone device is distinct, and a user may have more than one device, each device can in principle have its own distinct historical record. However, it can be arranged when the user first establishes or later updates his account that the user's Yahoo!ID is associated with a plurality of mobile phones and, upon signing in, the user can have access to his historical record from any one of these mobile phones. Thus, in a situation where the Yahoo!Photos program is deleted somehow or photos in the mobile album are erased for some reason the historical record provides a mobile album backup for restoring that album.

To that end, when the user reloads the application, it will query the user as to whether the user wishes to restore any of the mobile album photos. That is, when the user selects the query “where are my photos?” (in page 3.1.4) the ‘restore album’ page is displayed (3.1.4.2). As with the previous page (3.1.4), this page allows the user to go to the ‘home’ page (2.0) and, this time via ‘OK’, it allows the user to go to the next mobile ‘restore album’ page (3.1.4.2.1) for a historical photo download list (of photos previously downloaded to the mobile phone).

FIG. 6E illustrates in more detail the flow of restoring the mobile album from the server backup. Specifically, after traversing the ‘home’ and ‘mobile album empty’ pages (2.0 and 3.1.4), the user lends on the ‘restore album’ page (3.1.4.2). On selecting the ‘OK’ option, if the user is logged in the Yahoo!Photos server responds with the download history list of photos (steps 33, 35). This response prompts the mobile device to bring up the ‘restore album’ page (3.1.4.2.1) with the download history list of, say, 20 last photos that were added to the mobile album. From this historical list, the photos can be picked (see, e.g., checkmarks) and then the selected photos can be restored to the mobile album using the save/cancel menu options. The selected photos are then downloaded from the server in a batch process (step 37). The mobile album is then available for user access via ‘mobile album’ page (3.1.1).

Note that the pages shown in FIGS. 6A-6E and discussed herein are exemplary rather than exhaustive, and they do not necessarily include all possible pages (or user interaction cards) that a photo application such as Yahoo!Photos presents. Moreover, the reference designations (call-out numbers) typically refer to the pages themselves rather than any portion of their content. Where applicable, similar pages appear in different figures with the same call-out numbers, e.g., home page 2.0, although their respective contents can vary slightly.

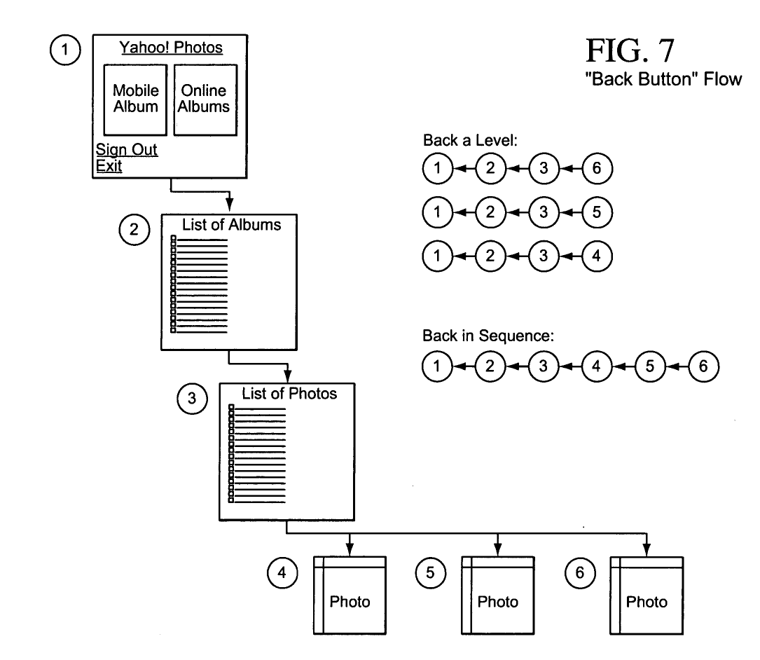

As to navigating through the pages in the context of a mobile application such as Yahoo!Photos on the mobile phone, the pages can be traversed forward as described above and they can be traversed backwards using the “back button” feature. FIG. 7 provides a simplified diagram to illustrate the “back button” feature. As can be seen, the “back a level” mode allows hierarchical backwards sequence traversal one level each time the ‘back’ button is touch activated or clicked (hereafter “clicked”). The “back in sequence” mode allows sequential backwards one page each time the ‘back’ button is pressed. For example, in back a level mode, back a level takes the application from a photo page (e.g., 6) one level up to the list of photos page (3); and from there one more level up to the list of albums page (2) and one more level up to the home page (1). As can be further seen in this example, the back in sequence mode functions to take the application from the current photo page (6) to the former photo page (5), rather than up one level (3), when the back button is touched. Additional activations of the back button will traverse through all the pages in reverse sequence.

It makes no difference if the ‘back’ button feature is used while in the online album or mobile album part of the application. The principles apply equally well to both situations. Either way, the steps (pages traversed) are remembered, and they can be recorded server side, locally, or both on the server side and locally. Again, the mobile application has its own user interface and the ‘back’ logic is implemented in the context of a mobile application outside the browser environment. As a result, the ‘back’ logic is platform independent and the ‘back’ button feature in entirely separate from the back function in the browser environment.

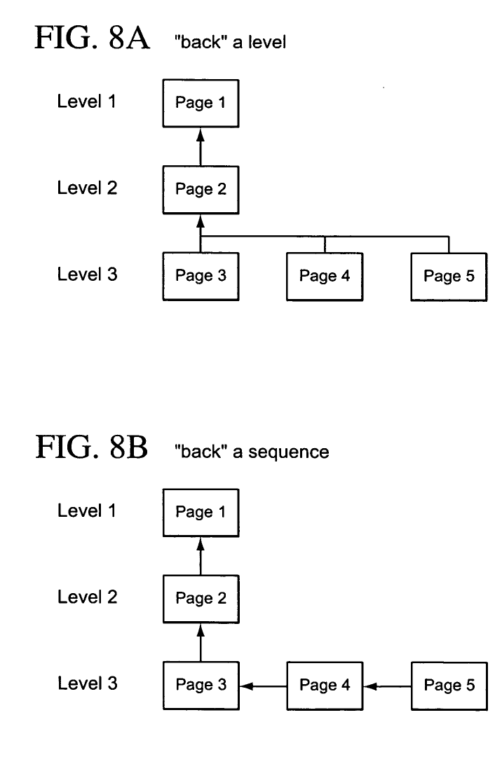

The following describes in more detail the forward and backward traversal and, in particular, the functionality and implementation of the ‘back’ button feature. As noted, there are 2 different modes for “back” action. The actual user experience that results from clicking the ‘back’ button varies with these modes. For each of the scenarios, we assume that a user applies 4 clicks to move from Page 1 to Page 5. FIGS. 8A and 8B illustrate the user experience resulting from clicking the ‘back’ button. When sequencing forward the user traverses the pages in the order of: Page 1→Page 2→Page 3→Page 4→Page 5. When the user is on Page 2, Page 3, Page 4 or Page 5, and clicks “back,” the user reverts back to a particular page based on the mode. In the mobile application, unlike in the browser, “page” does not refer to a specific web page. Instead, it represents a static GUI presentation when the client reaches a stable state.

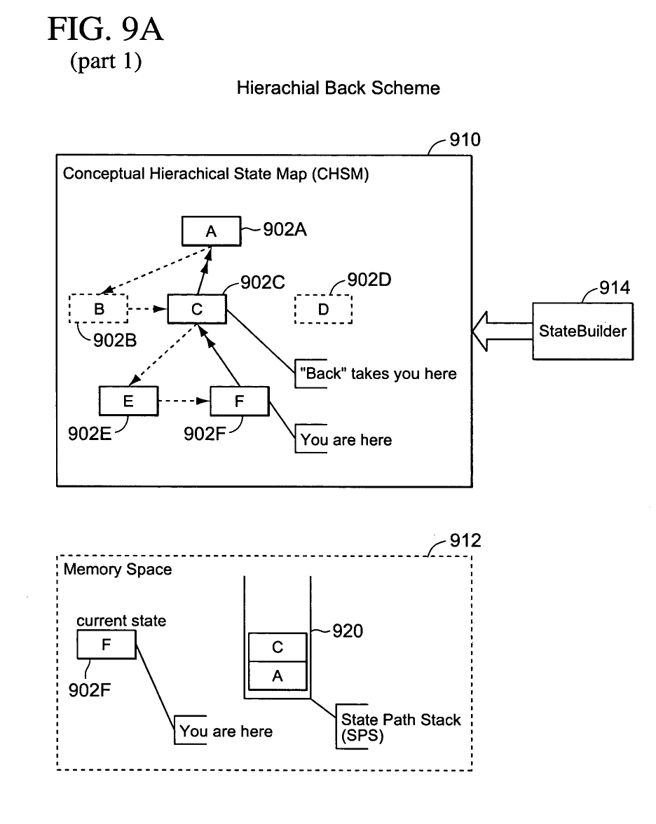

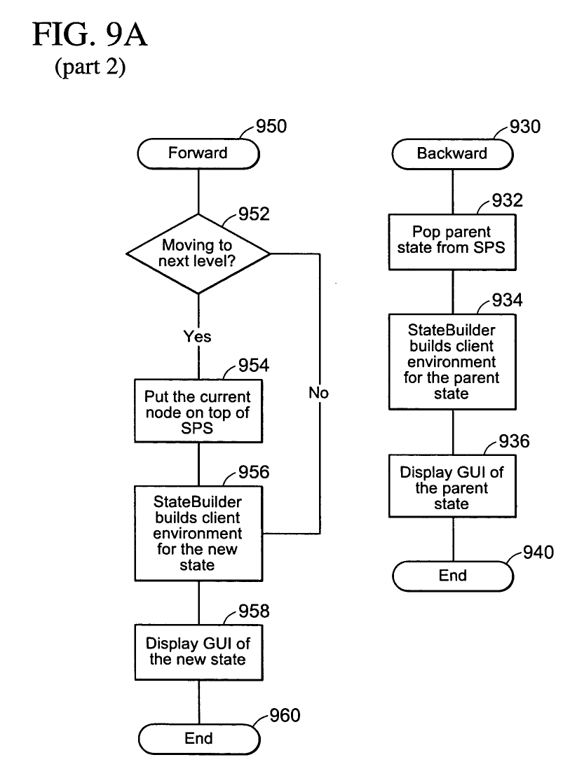

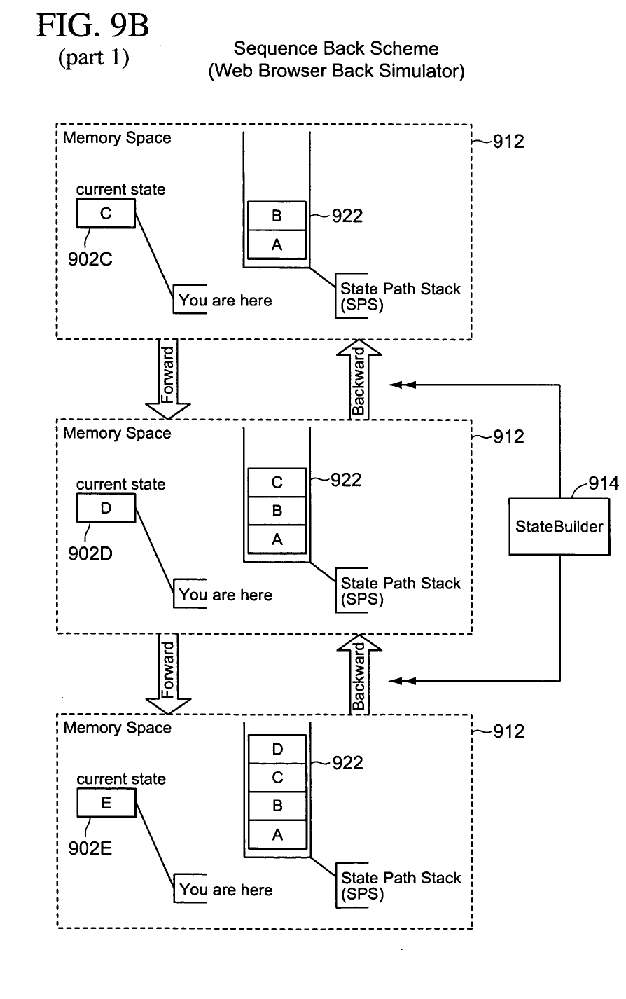

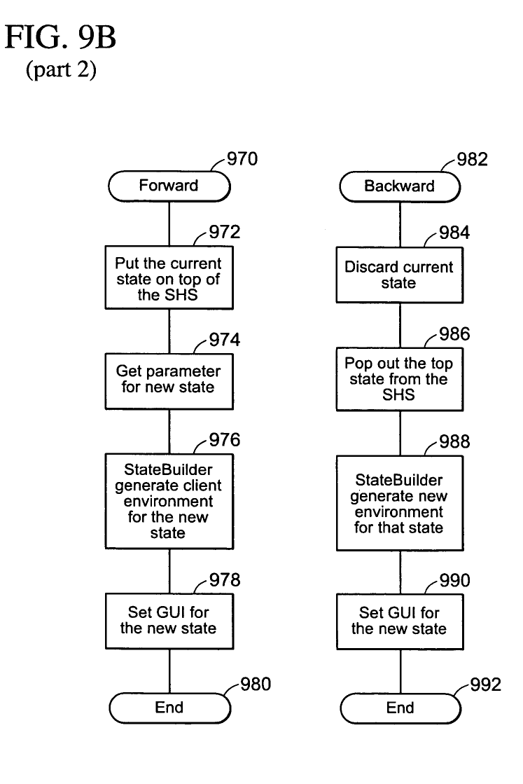

In order to accomplish the backwards level and sequential traversals, the client side architecture also includes the architectural features for implementing the back button. FIGS. 9A and 9B illustrates the architecture and functionality of the “back” feature. (In treating each mode, FIGS. 8A and 9A, and FIGS. 8B and 9B will be discussed correspondingly).

Starting with the example as shown in FIG. 8A, in the “back a level” mode, when on Page 2, the user clicks the ‘back’ button to revert to Page 1. When on Page 3, the user reverts back to Page 2. When on Page 4, the user clicks the ‘back’ button to revert to Page 2, i.e., back a level rather than in sequence. When on Page 5, the user clicks the ‘back’ button to revert, back a level, to Page 2.

With respect to the back-a-level traversal, as shown in FIG. 9A, for applications that involve a hierarchical navigation, there exist a conceptual hierarchical state map (CHSM) 910 of the application logic. In the CHSM, the states are nodes (902_{A-F}) represented by alpha characters such as the letters A-F, and the map is represented by a hierarchical structure that includes the nodes and edges between the nodes. Note that the doted lines in the CHSM represent the real path through which the client-side application arrives at a state, e.g., state F.

At any point when the user lands on a page (a stable screen), the client application (i.e., client Yahoo!Photos) enters a stable state (e.g., 902_{F}). Each state can be described with a set of parameters that are saved in memory 912 in the state data structure. Moreover, a state path stack (SPS) 920, configured as a first-in last-out (FILO) stack, holds a state path that records the current and all upspring nodes at each point of traversing the hierarchy. The state builder 914 is an engine that sets up all client runtime environments using parameters from a given state. The state builder 914 takes the parameter data for each state (e.g., 902_{F}) from the memory 912.

In the forward flow (starting at 950), only parent states are recorded in the SPS. That is, if the move from a current state to a new current state involves transition to the next level in the hierarchy 952 (i.e., a move from a parent to a child state rather than to a sibling state), the parent state will be ‘loaded’ on the SPS 954 (i.e., information of the parent state will be pushed on top of the SPS) and the state builder sets up the client environment for the current state 956. If the move is not to the next level, however, state builder is activated to set up the environment for the new current state 956 without loading the SPS. After the environment is set up, the program displays the graphic user interface (GUI) relative to the next state 960.

In the hierarchical backwards flow (starting at 930), each time the ‘back’ button is clicked the last state loaded on the SPS is popped from the SPS and selected as the current state (node) 932. The state builder 914 sets up the client environment according to the newly selected current state parameters 934, and prompts the corresponding GUI on the mobile phone display 936.

Note that this strategy can be best used for applications that map to a hierarchical navigation logic, such as the Yahoo!Photos application environment. Since the depth of the hierarchy is usually small and the state path is not expected to run longer and require more than this depth, any stack space limitations would not be significant.

To demonstrate the “back in sequence” mode, we turn again to FIG. 8B, where the traversal goes in backward sequence through each of the pages formerly traversed in the forward flow. That is, from Page 2 a user clicking the ‘back’ button goes to Page 1. A user on Page 3 clicks the ‘back’ button to go to Page 2, and, in further sequential manner, from Page 4 to Page 3, and from Page 5 to Page 4.

In order to accomplish sequential backwards traversals, a state path stack (SPS) is introduced for client-side applications, as shown in FIG. 9B. The SPS 922 is FILO stack holding information of each state traversed in the forward flow (unlike the SPS 920 in FIG. 9A that is loaded with state information only for moves to a next level). The flow diagrams in FIG. 9B show how the SPS 922 is used during forward and backward navigation.

Each time a user lands on a new page (stable screen), the new state in the forward flow becomes the current state and information for the previous states, if this is not the first state (home page), is loaded on top of the SPS 972. The parameter information for the new state is obtained 974, and the state builder generates a new environment for this state 976. This is followed by display of the GUI for leading to the next page 978 (e.g., prompts or selection items such as ‘OK’). In a sequential backwards traversal, the current state is discarded 984 and the last-in state information is popped out (unloaded from the top) of the SHS 986 to become the new current state. The state builder generates a new environment for the (new) current state 988 and the GUI is provided for the current state (i.e., for forward flow) 990.

The block diagrams in FIG. 9B, show how the SPS is loaded (and unloaded) in forward and backward moves of the in-sequence traversal. As with the hierarchical backward flow strategy, the concepts of state and state path are used to record the path through which a client application program traverses toward the current state. SPS is also used as the mechanism to store the state path, and the state builder 914 is used for setting up the client environment for the given state.

The difference between the sequential backwards traversal and the hierarchical backwards traversal is demonstrated in the content of the SPS. For sequential backwards traversal, the path in the SPS 922 records all sequential states through which the client application traverses toward the current state, and there is no concept of hierarchy. The forward flow process provides that the current state is always loaded at the top of the SPS 922. With some exceptions, the sequential backwards traversal is similar to the hierarchical backwards traversal. The two approaches differ in the size of the SPS. In the hierarchical backwards traversal (i.e., back a level mode) the size of the SPS 920 is capped by the depth of logical hierarchy. The size of the SPS 922 in the sequential backwards traversal (i.e., back in sequence mode) can grow as long as the user keeps using the client application within a single session. However, to avoid risk of memory overflow, a preset limit to the size of the SPS should be in place. From the user's perspective, this means that the user may go back as far as the user wishes.

Implementation Details

Additional implementation details associated with the foregoing description are provided below. These implementation details include an initial list of devices, soft key mapping, labels, global elements and screen flows tables for the online albums and mobile albums. These details are described in the following pages.

Possible Mobile Devices

The visual and interaction design as described herein should accommodate various types of mobile devices, including, for example, those listed in the table below.

| VENDOR | MODEL | USABLE PIXEL DIMENSIONS |
|---|---|---|
| Audiovox | 8450 | 128 × 112 |
| Samsung | A660 | 128 × 146 (without Soft key) |
| | | 128 × 131 (with Soft key: 15) |
| Sanyo | RL2000 (7200) | 120 × 112 (include soft key) |
| Sanyo | RL2500 (5400) | 132 (W) × 160 (H) including Soft key |
| Sanyo | 5500 | 132 (w) × 160 (h) including Soft key |
| Sony Ericsson | T608 | 128 × 114 pixels |
| Toshiba | 9950 | 261 × 240 |
| Hitachi | SH-P300 | 120 w × 130 h |
| LG | 5350 | 120 × 96 |
| Samsung | A500 | 128 × 146 (without Soft key) |
| | | 128 × 131 (with Soft key: 15) |
| Samsung | N400 | 128 × 114 (without Soft key) |
| | | 128 × 102 (with Soft key: 12) |
| Samsung | A600 | 128 × 146 (without Soft key) |
| | | 128 × 131 (with Soft key: 15) |
| Samsung | VGA1000 | 128 × 146 (without Soft key) |
| | (A620) | 128 × 131 (with Soft key: 15) |
| Sanyo | 4900 | 120 × 112 includes Soft key |
| Sanyo | 5300 | 132 × 160 (includes soft key) |
| Sanyo | 8100 | 128 × 120 (with soft key) |
| | | 120 × 112 (without Soft key) |

Soft Key Mapping

For the purpose of this invention, the following keys are available on the mobile devices: Up; Down; Left; Right; Select/OK; Left Soft key; Right Soft key; and Back. If a device does not have an obvious select key, it is assumed that the MIDP (mobile information device profile) implementation will automatically provide a select option at one of the soft keys or in one of the soft key menus.

KEY MAPPING

| | |
|---|---|
| Up | Scrolls the cursor up, or selects the previous item in a list. |
| Down | Scrolls the cursor down, or selects the next item in a list. |
| Left | Scrolls the cursor left if possible. |
| Right | Scrolls the cursor right if possible. |
| Select | LINK OR BUTTON: Go to appropriate screen |
| | EXCLUSIVE LIST (Radio buttons): Selects the radio button. |
| | MULTIPLE LIST (Checkboxes): Checks and un-checks the checkboxes. |
| | TEXTBOX: Takes the user to the text editor |
| | TEXT STRING: Does nothing |
| Two Soft keys | Soft key functionality varies greatly among devices. The ordering and |
| | positioning of options can't be controlled with any degree of accuracy; the |
| | order shown indicates only the relative importance of the options. |
| | In the examples presented herein, options are assigned a type (BACK, EXIT, |
| | ITEM) |
| | The following layout is preferred: |
| | Item 1: primary soft key |
| | Item 2: If no others are present, secondary soft key should have item 2 as its |
| | label. If additional items are available they should be listed in priority order in |
| | the menu, which is accessed via the secondary soft key. |
| | Primary soft key should have the same function as the ‘Enter’/‘OK’ key |
| Back | ‘Back’ button links back to previous screen. |
| | Does NOT link one level up in the navigation tree, unless that is the previous |
| | screen. |
| | Does not link back to confirmation or error popups. |
| | When technical constraints exist, data previously entered into fields may not |
| | be shown when user navigates back to a page. However, actual |
| | implementations may differ based on the technical constraints. |
| Default | In general, the first item on a page is pre-selected (default item) unless the user |
| Selection | has performed some action, like viewing or renaming an image. |
| Misc. keys | If arrow buttons on the side of the phone are available they should scroll down |
| | an entire page in a list or thumbnail screen. |
| | Image names should appear bold/strong when displayed on an instructional |
| | screen, e.g. 2.1.4. Normal text should be used for lists of images. |
| | In this document any underlined item is a link. Actual presentation of links, |
| | whether underlined or other, is determined by the device. |

Soft Key & Menu Labels

In a representative implementation, labels that may appear on a soft key are restricted to 7 characters. Menu-only items are restricted to 14 characters.

Common Labels

| | |
|---|---|
| OK | Performs the default action for a screen or for a selected item. Moves the user |
| | forward in a task. (e.g., opens an album or photo.) |
| Cancel | Used in addition to “Back” when an action was initiated and can be cancelled. |
| | Cancel usually performs same action as back, but is displayed to increase user |
| | confidence that the action was cancelled. |
| Edit | When possible, “Edit” links to a textbox editing screen. |
| Open | Opens a folder, message, file, etc. Should not be used for links not associated |
| | with files, folders, etc. |
| Back | “Back” label should be used only for the Back function described above. If |
| | possible, Back should always map only to the device back button. |
| Home | Links to the home screen of the MIDlet. |

Global Elements
Confirmation Popup

One type of global elements, presented as “Confirm Popup” screens, are used for displaying a confirmation to the user. The confirmation popup screens contain simple text such as “Done” or “Saved”, and they disappears automatically after a short time.

In Progress Screen

The “in progress” screen informs the user that the application is waiting for a response from the server or is processing a request. Each device has a default screen with text and a moving graphic, and, alternatively, it is replaced with a Yahoo! Canvas screen.

Screen Flows: Online Albums

As described above, the online album pages are made available to the user in forward and backwards traversal; each page having default selection items associated with it. The forward traversal starts, of course, with the home page (2.0). The following tables outline for each page separately the default selection items available in that page for screen flows.

2.0 J2ME Client Home

| Default | Mobile Album | | | | |
|---|---|---|---|---|---|
| Selection | | | | | |
| | | | Pref. | | |
| Actions | Label | Function | Location | Type | Priority |
| | | Left soft key opens selected | Primary | ITEM | 1 |
| | | page. | Soft key, | | |
| | | Numbers 1, 2, 3, 4 also open | OK Button | | |
| | | pages. | | | |

| | |
|---|---|
| Enter/OK | Open |
| Up Arrow | Select previous item |
| Down Arrow | Select next item |
| Left Arrow | Select next item |
| Right Arrow | Select previous item |
| Comments | Descriptive text and/or graphics will be added to this screen. Icons may be |
| | used in place of text links. |
| | “Sign Out” appears only when user is signed in. |

1.0 Sign In

| Default | ID Field. | | | | |
|---|---|---|---|---|---|
| Selection | | | | | |
| | | | Pref. | | |
| Actions | Label | Function | Location | Type | Priority |
| | Edit | Opens selected textbox for | Primary | EDIT | 1 |
| | | editing | Soft key, | | |
| | | | OK Button | | |
| | SignIn | Submits Form | Secondary | OK | 1 |
| | | | Soft key | | |
| | Back | 2.0 J2ME Client Home | Back | BACK | 1 |
| | | | button | | |

| | |
|---|---|
| Up Arrow | Jumps up. |
| Down Arrow | Jumps down. |
| Left Arrow | — |
| Right Arrow | — |
| Comments | Cache as much as legally & technically possible. |

2.1 My Online Albums

| Default | First Album, or last selected album in current session. | | | | |
|---|---|---|---|---|---|
| Selection | | | | | |
| Primary Soft | Open. Same as Enter. | | | | |
| key | | | | | |
| | | | Pref. | | |
| Actions | Label | Function | Location | Type | Priority |
| | Open | Opens selected album to | Primary | ITEM | 1 |
| | | last-used view—2.1.1 or | Soft key, | | |
| | | 2.1.2. List is default. | OK Button | | |
| | | If album contains no | | | |
| | | images, opens 2.1.6 Photos | | | |
| | | List Empty. | | | |
| | Back | Previous screen. | Back | BACK | 1 |
| | | | button | | |

| | |
|---|---|
| Up Arrow | Jumps to previous item in list. If top item is selected, does nothing. |
| Down Arrow | Jumps to next item in list. If last item is selected, does nothing. |
| Left Arrow | — |
| Right Arrow | — |

2.1.1 Photos Thumbs

| Default | One thumbnail is always selected. Selection is | | | | |
|---|---|---|---|---|---|
| Selection | indicated by 2 pixel black border. | | | | |
| | When scrolling to a page either (1) or (4) is selected. | | | | |
| | When returning from a list view, full-screen view, or action screen the last | | | | |
| | selected image is selected. | | | | |
| | | | Pref. | | |
| Actions | Label | Function | Location | Type | Priority |
| | Open | Opens 2.1.3 Online Photo | Primary | ITEM | 1 |
| | | NOTE: pressing 1, 2, 3, or | Soft key, | | |
| | | 4 opens the photo | OK Button | | |
| | | currently in that position. | | | |
| | Add to | Saves image to mobile | Menu | ITEM | 2 |
| | Mobile | album and opens 2.1.7 | | | |
| | Album | Added to Mobile | | | |
| | Screen | Links to 2.1.4 Save as | Menu | ITEM | 3 |
| | Saver | Screensaver | | | |
| | Email | Links to 2.1.5 Share as | Menu | ITEM | 3 |
| | Photo | Email | | | |
| | Photo | Links to 2.1.2 Photo List | Menu | SCREEN | 1 |
| | List | | | | |
| | Online | Links to 2.1 My Online | Menu | SCREEN | 2 |
| | Albums | Albums | | | |
| | Home | Links to 2.0 J2ME Client | Menu | SCREEN | 3 |
| | | Home | | | |
| | Back | Previous screen | Back | BACK | 1 |
| | | | button | | |

| | |
|---|---|
| Up Arrow | When (3) or (4) is selected, jumps up to (1) or (2). |
| | When (1) or (2), moves up one row. |
| Down | When (1) or (2) is selected, jumps down to (3) or (4). |
| Arrow | When (3) or (4), moves down one row. |
| Left Arrow | Cycle through all thumbs on the screen, (4)-(1) then to the row above. Rows |
| | are added one at a time, so the top row shifts down when a new row is |
| | loaded. |
| Right Arrow | Cycle through all thumbs on the screen, (1)-(4) then to the row below. Rows |
| | are added one at a time, so the bottom row shifts up when a new row is |
| | loaded. |
| Comments | List loops back to beginning when user reaches last image. When looping to |
| | the beginning, the full screen refreshes with 2 rows of images. |
| | Each photo is surrounded by 2 pixels of white space. The selected photo has |
| | a 2 pixel black border. |

2.1.2 Photo List

| Default | One item is always selected. | | | | |
|---|---|---|---|---|---|
| Selection | When returning from a thumbnail view, full-screen view, or action | | | | |
| | screen the last selected image is selected. | | | | |
| | After deleting, the image in the spot that contained the deleted image is | | | | |
| | selected. | | | | |
| | | | Pref. | | |
| Actions | Label | Function | Location | Type | Priority |
| | Open | Opens 2.1.3 Online | Primary | ITEM | 1 |
| | | Photo | Soft key, | | |
| | | | OK | | |
| | | | Button | | |
| | Add to | Saves image to | Menu | ITEM | 2 |
| | Mobile | mobile album | | | |
| | Album | | | | |
| | Screen | Links to 2.1.4 Save | Menu | ITEM | 3 |
| | Saver | as Screensaver | | | |
| | Email | Links to 2.1.5 Share | Menu | ITEM | 3 |
| | Photo | as Email | | | |
| | Thumbnails | Links to 2.1.1 Photo | Menu | SCREEN | 1 |
| | | Thumbs | | | |
| | Online | Links to 2.1 My | Menu | SCREEN | 2 |
| | Albums | Online Albums | | | |
| | Home | Links to 2.0 J2ME | Menu | SCREEN | 3 |
| | | Client Home | | | |
| | Back | Previous screen | Back | BACK | 1 |
| | | | button | | |

| | |
|---|---|
| Up Arrow | Jumps to previous item in list. If top item is selected, does nothing. |
| Down Arrow | Jumps to next item in list. If last item is selected, does nothing. |
| Left Arrow | — |
| Right Arrow | — |
| Comments | File extensions are displayed. |
| | Items are displayed in order specified by the Yahoo!Photos system. User |
| | cannot rename, delete, or move photos. |

2.1.3 Online Photo

| Default | — | | | | |
|---|---|---|---|---|---|
| Selection | | | | | |
| | | | Pref. | | |
| Actions | Label | Function | Location | Type | Priority |
| | Done | Links to 2.1.1 or 2.1.2 | Primary | SREEN | 1 |
| | | | Soft key | | |
| | Add to | Saves image to mobile | Menu | ITEM | 2 |
| | Mobile | album | | | |
| | Album | | | | |
| | Screen | Links to 2.1.4 Save as | Menu | ITEM | 3 |
| | Saver | Screensaver | | | |
| | Email | Links to 2.1.5 Share as | Menu | ITEM | 3 |
| | Photo | Email | | | |
| | Online | Links to 2.1 My | Menu | SCREEN | 2 |
| | Albums | Online Albums | | | |
| | Home | Links to 2.0 J2ME | Menu | SCREEN | 3 |
| | | Client Home | | | |
| | Back | Previous screen | Back | BACK | 1 |
| | | | button | | |

| | |
|---|---|
| Up Arrow | — |
| Down Arrow | — |
| Left Arrow | Jumps to previous image in gallery. |
| Right Arrow | Jumps to next image in gallery. |
| Comments | Image should be as large as possible on any particular screen. |

2.1.4 Save as Screensaver

| Default | Text entry field | | | | |
|---|---|---|---|---|---|
| Selection | | | | | |
| | | | Pref. | | |
| Actions | Label | Function | Location | Type | Priority |
| | OK | Initiates PCS Vision | Primary | SCREEN | 1 |
| | | download process. | Soft key, | | |
| | | | OK Button | | |
| | Cancel | Cancels operation and | Second | SCREEN | 2 |
| | | returns to previous | Soft key | | |
| | | screen | | | |
| | Back | Previous screen | Back | BACK | 1 |
| | | | button | | |

| | |
|---|---|
| Up Arrow | — |
| Down Arrow | — |
| Left Arrow | |
| Right Arrow | |
| Comments | |

2.1.5 Share as Email

| Default | Text entry field | | | | |
|---|---|---|---|---|---|
| Selection | | | | | |
| | | | Pref. | | |
| Actions | Label | Function | Location | Type | Priority |
| | Send | Send. Sends email to | Secondary | ITEM | 1 |
| | | recipients and user | Soft key | | |
| | | with link to image | | | |
| | | on web. | | | |
| | | Confirmation pops | | | |
| | | up for a moment, | | | |
| | | then user is returned | | | |
| | | to 2.1.1, 2.1.2, or | | | |
| | | 2.1.3. | | | |
| | | If email address was | | | |
| | | not formed correctly | | | |
| | | an error appears. | | | |
| | Edit/Pick/OK | Opens textbox for | Primary | | 1 |
| | | editing, toggles state | Soft key, | | |
| | | of checkbox, or | OK Button | | |
| | | sends. | | | |
| | Back | Previous screen | Back | BACK | 1 |
| | | | button | | |

| | |
|---|---|
| Up Arrow | — |
| Down Arrow | — |
| Left Arrow | — |
| Right Arrow | — |
| Comments | |

2.1.6 Photo List Empty

Default
Selection

| | | | Pref. | | |
|---|---|---|---|---|---|
| Actions | Label | Function | Location | Type | Priority |
| | Back | 2.1 My Online | Back | BACK | 1 |
| | | Albums | button | | |

| | |
|---|---|
| Up Arrow | — |
| Down Arrow | — |
| Left Arrow | — |
| Right Arrow | — |
| Comments | Displayed for a moment, then automatically |
| | links back to 2.1 My Online Albums |

Screen Flows: Mobile Album

As with the online album, the mobile album pages are made available to the user in forward and backwards traversal; each page having default selection items associated with it. Here again, the forward traversal starts, of course, with the home page (2.0). The following tables outline for each page separately the default selection items available in that page for screen flows.

3.1.1 Mobile Photo List

| Default | One item is always selected. | | | | |
|---|---|---|---|---|---|
| Selection | When returning from a thumbnail view, full-screen view, or action | | | | |
| | screen the last selected image is selected. | | | | |
| | After deleting, the image in the spot that contained the deleted image is | | | | |
| | selected. | | | | |
| | | | Pref. | | |
| Actions | Label | Function | Location | Type | Priority |
| | Open | Opens selected photo | Primary | ITEM | 1 |
| | | in 3.1.3 Mobile | Soft key, | | |
| | | Photo | OK | | |
| | | | Button | | |
| | Slideshow | Links to 3.3 Mobile | Menu | ITEM | 2 |
| | | Slideshow, starting | | | |
| | | show with current | | | |
| | | photo | | | |
| | Move | Links to 3.2.1 Move | Menu | ITEM | 4 |
| | Delete | Links to 3.2.4 Delete | Menu | ITEM | 4 |
| | Thumbnails | Links to 3.1.1 | Menu | SCREEN | 1 |
| | | Mobile- Photo | | | |
| | | Thumbs | | | |
| | Home | Links to 2.0 J2ME | Menu | SCREEN | 2 |
| | | Client Home | | | |
| | Back | Previous screen | Back | BACK | 1 |
| | | | button | | |

| | |
|---|---|
| Up Arrow | Jumps to previous item in list. If top item is selected, does nothing. |
| Down Arrow | Jumps to previous item in list. If last item is selected, does nothing. |
| Left Arrow | — |
| Right Arrow | — |
| Comments | File extensions are not displayed. |

3.1.2 Mobile Photo Thumbs

| | |
|---|---|
| Default Selection | One thumbnail is always selected. Selection is indicated by 2 pixel |
| | border. |
| | When returning from a list view, full-screen view, or action screen the |
| | last selected image is selected. |
| | After deleting, the image in the spot that contained the deleted image is |
| | selected. |
| | After Moving, the last moved image is selected. |

| Actions | Label | Function | Pref. Location | Type | Priority |
|---|---|---|---|---|---|
| | Open | Opens 3.1.3 Mobile | Primary | ITEM | 1 |
| | | Photo | Soft key, | | |
| | | NOTE: pressing | OK Button | | |
| | | 1, 2, 3, or 4 opens | | | |
| | | the photo currently | | | |
| | | in that position. | | | |
| | Slideshow | Links to 3.3 Mobile | Menu | ITEM | 2 |
| | | Slideshow, starting | | | |
| | | show with current | | | |
| | | photo | | | |
| | Move | Links to 3.2.1 Move | Menu | ITEM | 4 |
| | Delete | Links to 3.2.4 | Menu | ITEM | 4 |
| | | Delete | | | |
| | Photo List | Links to 3.1.1 | Menu | SCREEN | 1 |
| | | Mobile-Photo List | | | |
| | Home | Links to 2.0 J2ME | Menu | SCREEN | 2 |
| | | Client Home | | | |
| | Back | Previous screen | Back | BACK | 1 |
| | | | button | | |

| | |
|---|---|
| Up Arrow | When (3) or (4) is selected, jumps up to (1) or (2). |
| | When (1) or (2), moves up one row. |
| Down Arrow | When (1) or (2) is selected, jumps down to (3) or (4). |
| | When (3) or (4), moves down one row. |
| Left Arrow | Cycle through all thumbs on the screen, (4)-(1) then to the row above. |
| | Rows are added one at a time, so the top row shifts down when a new |
| | row is loaded. |
| Right Arrow | Cycle through all thumbs on the screen, (1)-(4) then to the row below. |
| | Rows are added one at a time, so the bottom row shifts up when a new |
| | row is loaded. |
| Comments | List loops back to beginning when user reaches last image. When |
| | looping to the beginning, the full screen refreshes all 4 images. |
| | When an image is deleted all other images move to fill the empty space |
| | Each photo is surrounded by 2 pixels of white space. The selected |
| | photo has a 2 pixel border. |

3.1.3 Mobile Photo

| Default Selection | — | | | | |
|---|---|---|---|---|---|
| Actions | Label | Function | Pref. Location | Type | Priority |
| | Done | Album. Links to most | Primary | ITEM | 1 |
| | | recent view of album - | Soft key, | | |
| | | 3.1.1 or 3.1.2 - with | OK | | |
| | | most recently viewed | Button | | |
| | | image selected. | | | |
| | Slideshow | Links to 3.3 Mobile | Menu | ITEM | 2 |
| | | Slideshow, starting | | | |
| | | show with current | | | |
| | | photo | | | |
| | Move | Links to 3.2.1 Move | Menu | ITEM | 4 |
| | Delete | Links to 3.2.4 Delete | Menu | ITEM | 4 |
| | Home | Links to 2.0 J2ME | Menu | SCREEN | 2 |
| | | Client Home | | | |
| | Back | Previous screen | Back | BACK | 1 |
| | | | button | | |

| | |
|---|---|
| Up Arrow | — |
| Down Arrow | — |
| Left Arrow | Jumps to previous image in gallery. When first image is reached, loops to |
| | end. |
| Right Arrow | Jumps to next image in gallery. When last image is reached, loops to |
| | beginning. |
| Comments | Image should be as large as possible on any particular screen. |

3.1.4 Mobile Album Empty

| Default Selection | My Online Albums | | | | |
|---|---|---|---|---|---|
| Actions | Label | Function | Pref. Location | Type | Priority |
| | OK | | Primary | ITEM | 1 |
| | | | Softkey, | | |
| | | | OK Button | | |
| | Back | Previous | Back | BACK | 1 |
| | | screen | button | | |
| Up Arrow | — | | | | |
| Down Arrow | — | | | | |
| Left Arrow | — | | | | |
| Right Arrow | — | | | | |
| Comments | — | | | | |

3.1.4.1 Mobile - About

| Default | My Online Albums | | | | |
|---|---|---|---|---|---|
| Selection | | | | | |
| Actions | Label | Function | Pref. Location | Type | Priority |
| | OK | Links to 2.1 | Primary | ITEM | 1 |
| | | My Online | Soft key, | | |
| | | Albums | | | |
| | | | OK Button | | |
| | Back | Previous screen | Back | BACK | 1 |
| | | | button | | |
| Up Arrow | — | | | | |
| Down Arrow | — | | | | |
| Left Arrow | — | | | | |
| Right Arrow | — | | | | |
| Comments | | | | | |

3.1.4.2 Mobile - Restore Album Info

| Default | My Online Albums | | | | |
|---|---|---|---|---|---|
| Selection | | | | | |
| Actions | Label | Function | Pref. Location | Type | Priority |
| | OK | Links to | Primary | ITEM | 1 |
| | | 3.1.4.2.1 | Soft key, | | |
| | | Restore Mobile | OK Button | | |
| | | Album | | | |
| | Back | Previous screen | Back | BACK | 1 |
| | | | button | | |
| Up Arrow | — | | | | |
| Down Arrow | — | | | | |
| Left Arrow | — | | | | |
| Right Arrow | — | | | | |
| Comments | | | | | |

3.1.4.2.1 Restore Mobile Album

Default
Selection

| Actions | Label | Function | Pref. Location | Type | Priority |
|---|---|---|---|---|---|
| | Pick | Toggles state | Primary | ITEM | 1 |
| | | of checkbox | Soft key, | | |
| | | | OK Button | | |
| | Save | Downloads | Secondary | SCREEN | 1 |
| | | all selected | Soft key | | |
| | | images to | | | |
| | | Mobile | | | |
| | | Album | | | |
| | Back | Previous | Back | BACK | 1 |
| | | screen | button | | |

| | |
|---|---|
| Up Arrow | Jumps to previous item in list. If top item is selected, does |
| | nothing. |
| Down Arrow | Jumps to next item in list. If last item is selected, does |
| | nothing. |
| Left Arrow | May toggle state of checkbox. |
| Right Arrow | May toggle state of checkbox. |
| Comments | This screen lists a close approximation of the items |
| | downloaded to a particular phone using a particular |
| | account. When the user has selected the photos he wishes to |
| | restore and presses “Save” all the images are |
| | downloaded to the mobile album. If the Mobile Album |
| | already has photos in it, restored photos are added |
| | at the bottom of the list. |

3.2.1 Move

| Default | Selected Photo | | | | |
|---|---|---|---|---|---|
| Selection | | | | | |
| Actions | Label | Function | Pref. Location | Type | Priority |
| | Done | Drops photo | Primary | OK | 1 |
| | | in current | Soft key, | | |
| | | location. Links | OK Button | | |
| | | to 3.2.1 with | | | |
| | | moved photo | | | |
| | | selected. | | | |
| | Back | Links to | Back | BACK | 1 |
| | | previous page | button | | |
| | | (before move | | | |
| | | command was | | | |
| | | selected) and | | | |
| | | cancels move. | | | |

| | |
|---|---|
| Up Arrow | When (3) or (4) is selected, swaps with (1) or (2). |
| | When (1) or (2) is selected, moves up one row. |
| Down Arrow | When (1) or (2) is selected, swaps with (3) or (4). |
| | When (3) or (4) is selected, moves down one row. |
| Left Arrow | When (1) is selected, jumps to previous screen and |
| | swaps with (4) on that screen. |
| | When (2) is selected, swaps with (1). |
| | When (3) is selected, swaps with (2). |
| | When (4) is selected, swaps with (3). |
| | When first image is selected, jumps to last image. |
| Right Arrow | When (4) is selected, jumps to previous screen and |
| | swaps with (1) on that screen. |
| | When (3) is selected, swaps with (2). |
| | When (2) is selected, swaps with (3). |
| | When (3) is selected, swaps with (4). |
| | When final image is selected, jumps to first image. |
| Comments | Small arrow images overlaid on the image being moved. |

3.2.4 Delete

| Default | — | | | | |
|---|---|---|---|---|---|
| Selection | | | | | |
| | | | Pref. | | |
| Actions | Label | Function | Location | Type | Priority |
| | Delete | Deletes photo | Primary | OK | 1 |
| | | and returns | Soft key | | |
| | | user to 3.1.1 or | | | |
| | | 3.1.2 (last used) | | | |
| | | with image in | | | |
| | | position of | | | |
| | | deleted image | | | |
| | | selected. | | | |
| | Cancel | Cancels deletion | Secondary | BACK | 2 |
| | | and links to | Soft key | | |
| | | previous screen | | | |
| | Back | Cancels deletion | Back | BACK | 1 |
| | | and links to | button | | |
| | | previous screen | | | |
| Up Arrow | — | | | | |
| Down Arrow | — | | | | |
| Left Arrow | — | | | | |
| Right Arrow | — | | | | |
| Comments | | | | | |

3.2.4 Delete All

| Default | — | | | | |
|---|---|---|---|---|---|
| Selection | | | | | |
| | | | Pref. | | |
| Actions | Label | Function | Location | Type | Priority |
| | Delete | Deletes all photos | Primary | OK | 1 |
| | | and returns user | Soft key | | |
| | | to 3.1.4 | | | |
| | | Mobile Album | | | |
| | | Empty. | | | |
| | Cancel | Cancels deletion and | Secondary | BACK | 2 |
| | | links to previous | Soft key | | |
| | | screen | | | |
| | Back | Cancels deletion and | Back | BACK | 1 |
| | | links to previous | button | | |
| | | screen | | | |

| | |
|---|---|
| Up Arrow | — |
| Down | — |
| Arrow | |
| Left | — |
| Arrow | |
| Right | — |
| Arrow | |
| Comments | |

3.3 Mobile Slideshow

| Default | — | | | | |
|---|---|---|---|---|---|
| Selection | | | | | |
| | | | Pref. | | |
| Actions | Label | Function | Location | Type | Priority |
| | Stop | Ends slideshow and | Primary | OK | 1 |
| | | returns user to 3.1.1 or 3.1.2 | Soft key | | |
| | | (last used). | | | |
| | Pause | Pauses slideshow and | Menu | SCREEN | 1 |
| | | switches first Action to | | | |
| | | “Play.” Pressing again | | | |
| | | re-starts slideshow | | | |
| | | from the current image. | | | |
| | Slow | Switches speed to Slow. | Menu | SCREEN | 2 |
| | Normal | Switches speed to Normal. | Menu | SCREEN | 3 |
| | Fast | Switches speed to Fast | Menu | SCREEN | 4 |

| | |
|---|---|
| Up Arrow | — |
| Down Arrow | — |
| Left Arrow | Jumps to previous image. Slideshow continues to play at same speed. |
| Right Arrow | Jumps to next image. Slideshow continues to play at same speed. |
| Comments | Image should be as large as possible on any particular screen. |
| | If possible, backlight should remain on until slideshow is stopped. |
| | Screen should not refresh while Actions menu is open. |
| | The screen has no header. |

Although the present invention has been described in accordance with the embodiments shown, variations to the embodiments would be apparent to those skilled in the art and those variations would be within the scope and spirit of the present invention. Accordingly, it is in tended that the specification and embodiments shown be considered exemplary only, with a true scope of the invention being indicated by the following claims and equivalents.

1. A method for backwards navigation on a mobile device with a voice or touch-activated command input and a state stack, comprising:
invoking platform-independent ‘back’ logic, wherein the platform-independent ‘back’ logic is provided with a mobile application that enables navigation through states;
detecting, while in a current state, a ‘back’ command, wherein the platform-independent ‘back’ logic is responsive to the ‘back’ command instituting backwards navigation from the current state;
popping out a state from the state stack in response to the ‘back’ command, the popped out state replacing the current state as the new current state;
generating a run-time environment in the mobile device for the new current state; and
displaying a screen associated with the new current state along with a user interface to other states.

2. A mobile device as in claim 1, wherein the ‘back’ command is received from a voice or touch-activated input.

3. A method as in claim 1, wherein the backwards navigation is conducted either in a back in sequence mode or in a back a level mode.

4. A method as in claim 3 where, in the back in sequence mode, the popped out state is a last-in state removed from the top of the state stack, and in the back a level mode, the popped out state is a parent state removed from the top of the state stack.

5. A method as in claim 3 where, in the back in sequence mode, the state stack holds a sequential state path that records a sequential forward flow through each state up to the current state.

6. A method as in claim 5, further comprising, in the back in sequence mode, recording the forward flow in a state history stack for future restoration of user interactions.

7. A method as in claim 3 where, in the back a level mode, the state stack holds a hierarchical state path, recording parent states in a forward flow up to the current state, such that the backwards navigation follows the hierarchical state path in reverse.

8. A method as in claim 1, wherein the mobile application is a mobile photos application, and wherein the run-time environment in the mobile device is generated for a client-side of the mobile photos application.

9. A method as in claim 1, wherein the mobile application is a mobile photos application, and wherein the mobile photos application provides for forward and backwards navigation through states corresponding to screens associated with a mobile album of photos or an online album of photos.

10. A mobile device with a touch-activated ‘back’ command, comprising:
a ‘back’ command input;
means for invoking platform-independent ‘back’ logic, wherein the platform-independent ‘back’ logic is deployed in a mobile application that enables navigation through states;
means for detecting, while in a current state, a ‘back’ command from the ‘back’ command input;
a data structure for holding the states;
means for popping out a state from the data structure in response to the ‘back’ command, the popped out state replacing the current state as the new current state, wherein the platform-independent ‘back’ logic is responsive to the ‘back’ command instituting backwards navigation from the current state;
means for generating a run-time environment in the mobile device for the new current state; and
means for displaying a screen associated with the new current state along with a user interface to other states.

11. A mobile device as in claim 10, wherein the ‘backwards navigation is conducted on the mobile device either in a back in sequence mode or in a back a level mode.

12. A mobile device as in claim 11, wherein the data structure is a state stack, and where, in the back in sequence mode, the popped out state is a last-in state removed from the top of the state stack, and in the back a level mode, the popped out state is a parent state removed from the top of the state stack.

13. A mobile device as in claim 11 where, in the back in sequence mode, the data structure holds a sequential state path that records a sequential forward flow through each state up to the current state.

14. A mobile device as in claim 13, further comprising a state path data structure for holding the forward flow in the back in sequence mode.

15. A mobile device as in claim 13 where, in the back a level mode, the data structure holds a hierarchical state path, recording parent states in a forward flow up to the current state, such that the backwards navigation follows the hierarchical state path in reverse.

16. A mobile device as in claim 11, wherein the mobile application is a mobile photos application, and wherein the run-time environment in the mobile device is associated with a client-side of the mobile photos application, the client-side of the mobile photos application being dynamically loadable to the mobile device on demand from a server via the Internet and a bearer network.

17. A mobile device as in claim 10, wherein the mobile application is a mobile photos application, and wherein the mobile photos application provides for the forward and backwards navigation through states corresponding to screens associated with a mobile album of photos or an online album of photos.

18. A mobile device as in claim 10, operative as a wireless, mobile camera phone capable of capturing images and uploading the captured images to a server via a bearer network and the internet.

19. A mobile device as in claim 10, configured as a wireless mobile device capable of dynamically pulling data form and pushing data to a server via a wireless network and the Internet.

20. A mobile device as in claim 10, operative as a wireless application protocol-compliant device.

21. A mobile computer system embodying a touch-activated ‘back’ command input, a data structure for holding states, and a memory having program code for backwards navigation responsive to ‘back’ commands comprising:
program code for responding to invocation of a platform-independent ‘back’ logic which is deployed in a mobile application that enables navigation through states;
program code for responding, while in a current state, to a ‘back’ command from the touch activated ‘back’ command input, wherein the platform-independent ‘back’ logic is responsive to the ‘back’ command instituting backwards navigation from the current state;
program code for popping out a state from the data structure in response to the ‘back’ command, the popped out state replacing the current state as the new current state;
program code for generating a run-time environment in the mobile device for the new current state; and
program code for displaying a screen associated with the new current state along with a user interface to other states.

22. A mobile device as in claim 21, wherein the backwards navigation is conducted on the mobile device either in a back in sequence mode or in a back a level mode.

23. A mobile device as in claim 22, wherein the data structure is a state stack, and where, in the back in sequence mode, the popped out state is a last-in state removed from the top of the state stack, and in the back a level mode, the popped out state is a parent state removed from the top of the state stack.

24. A mobile device as in claim 22 where, in the back in sequence mode, the data structure holds a sequential state path that records a sequential forward flow through each state up to the current state.

25. A mobile device as in claim 24, further comprising a state path data structure for holding the forward flow in the back in sequence mode.

26. A mobile device as in claim 22 where, in the back a level mode, the data structure holds a hierarchical state path, recording parent states in a forward flow up to the current state, such that the backwards navigation follows the hierarchical state path in reverse.

27. A mobile device as in claim 21, wherein the mobile application is a mobile photos application, and wherein the run-time environment in the mobile device is associated with a client-side of the mobile photos application, the client-side of the mobile photos application being dynamically loadable to the mobile device on demand from a server via the Internet and a bearer network.

28. A mobile device as in claim 27, wherein the mobile application is a mobile photos application that provides for forward and backwards navigation through states corresponding to screens associated with a mobile album of photos or an online album of photos.

29. A mobile device as in claim 21, operative as a wireless, mobile camera phone capable of capturing images and with further program code for uploading the captured images to a server via a bearer network and the internet.

30. A mobile device as in claim 21, operative as a wireless mobile device capable of dynamically pulling data form and pushing data to a server via a wireless network and the Internet.

31. A mobile device as in claim 21, having program code for operating as a wireless application protocol-compliant device.

32. A mobile device comprising:
a ‘back’ command input;
a ‘menu’ command input; and
a memory for storing a mobile client application in which ‘back’ logic is deployed, the ‘menu’ command input operative for activating the mobile client application which is responsive, in turn, to the ‘back’ command input by providing, via the ‘back’ logic, backwards navigation through screens in ‘back in sequence’ mode or ‘back a level’ mode.

33. A mobile device as in claim 32, further comprising:
a display having resolution for text and graphic display, including display of a menu screen associated with the ‘menu’ command input; and
a selection command input for selecting a menu item from the menu screen or for selecting an action or menu item from another screen.

34. A mobile device as in claim 33, wherein the ‘menu’ command and selection command inputs are operative to allow forward flow of screens.

35. A mobile device as in claim 34, further comprising a state stack operative to record the forward flow either sequentially or hierarchically, thereby enabling the backwards navigation.

36. A mobile device as in claim 34, further comprising a state history stack operative to record the forward flow for future restoration of user interaction.

37. A mobile device as in claim 33, operative as a wireless, mobile camera phone operative to capture images and upload the captured images to a server via a bearer network and the internet.

38. A mobile device as in claim 32, operative as a wireless application protocol-compliant device.

39. A mobile device as in claim 32 with functionality and profile implemented using a Java 2 Micro Edition (J2ME™) platform.

40. A mobile device as in claim 32, wherein the touch-activated ‘back’ command input includes a button, a soft key, or an icon.

41. A wireless system with mobile devices having a ‘back’ command input, comprising:
a carrier network;
a network including at least the Internet;
a server;
a plurality of mobile devices interconnected with the server via the carrier network and the network and being capable of communicating with each other via the server, one or more than one mobile device having ‘back’ command input and a memory for receiving a mobile client application from the server, wherein the mobile client application includes ‘back’ logic is responsive, via the ‘back’ logic, to the ‘back’ command input by providing backwards navigation through screens in ‘back in sequence’ mode or ‘back a level’ mode.

42. A wireless system as in claim 41, further comprising a carrier gateway disposed between the carrier network and the network for tracking subscriber activities and controlling their data communications, as well as, for functioning as a proxy for the mobile devices, on one hand, and for the server, on the other hand.

43. A wireless system as in claim 41, wherein the one or more than one mobile device with the ‘back’ command input and memory for receiving the mobile client application further has a ‘menu’ command input to which the mobile device is responsive for activating the mobile client application.

44. A wireless system as in claim 43, in which the one of more than one mobile device with the ‘back’ command input, the ‘menu’ command input, and the memory for receiving the mobile client application further includes:
a display having resolution for text and graphic display, including display of a menu screen associated with the ‘menu’ command input; and
a selection command input for selecting a menu item from the menu screen or for an action or menu item from another screen.

45. A wireless system as in claim 44, wherein the ‘menu’ command and selection command inputs are operative to allow forward flow of screens.

46. A wireless system as in claim 45, in which the one of more than one mobile device with the ‘back’ command input, the ‘menu’ command input, and the memory for receiving the mobile client application further includes a state stack for recording the forward flow either sequentially or hierarchically, thereby facilitating the backwards navigation.

47. A mobile device as in claim 45, in which the one of more than one mobile device with the ‘back’ command input, the ‘menu’ command input, and the memory for receiving the mobile client application further includes a state history stack for recording the forward flow for future restoration of user interaction.

48. A mobile device as in claim 44, in which the one of more than one mobile device with the ‘back’ command input, the ‘menu’ command input, and the memory for receiving the mobile client application, is operative as a wireless, mobile camera phone capable of capturing images and uploading the captured images to the server via network and the carrier network.

49. A mobile device as in claim 41, wherein the ‘back’ command input is a button, an icon a soft key or a voice activated input.

50. A method for backwards navigation on a mobile device with a command input and a state stack, comprising:
invoking a mobile application that enables navigation through states;
detecting, while in a current state of the mobile application, a ‘back’ command to the from the command input;
instituting, in response to the ‘back’ command, backwards navigation from the current state, wherein the mobile application provides for backwards navigation in a back in sequence mode and in a back a level mode;
popping out a state from the state stack in response to the ‘back’ command, the popped out state replacing the current state as the new current state;
generating a run-time environment in the mobile device for the new current state; and
displaying a screen associated with the new current state along with a user interface to other states.

51. A mobile device as in claim 50, wherein the ‘back’ command input is a voice or touch-activated command input.

52. A method as recited in claim 50 where, in the back in sequence mode, the popped out state is a last-in state removed from the top of the state stack, and in the back a level mode, the popped out state is a parent state removed from the top of the state stack.

53. A method as in claim 50 where, in the back in sequence mode, the state stack holds a sequential state path that records a sequential forward flow through each state up to the current state.

54. A method as in claim 50, further comprising, in the back in sequence mode, recording the forward flow in a state history stack for future restoration of user interactions.

55. A method as in claim 50 where, in the back a level mode, the state stack holds a hierarchical state path, recording parent states in a forward flow up to the current state, such that the backwards navigation follows the hierarchical state path in reverse.

56. A method as in claim 50, wherein the mobile application is a mobile photos application, and wherein the run-time environment in the mobile device is generated for a client-side of the mobile photos application.

57. A method as in claim 50, wherein the mobile application is a mobile photos application, and wherein a client-side of the mobile photos application provides for forward and backwards navigation through states corresponding to screens associated with an album of photos.

58. A method as in claim 50, wherein the mobile application is a mobile photos application such that the navigation, forward and backwards, is through states corresponding to screens associated with an album of photos, and wherein if any one of the photos on a screen is deleted the backwards navigation cancels this deletion.

59. A method as in claim 50, wherein the mobile application is a mobile photos application such that the navigation, forward and backwards, is through states corresponding to screens associated with an album of photos, and wherein if a photo is moved to another location on a screen the backwards navigation returns the photo to its previous location.

60. A method as in claim 50, wherein the mobile application generates a pop-up message which the backwards navigation omits.

61. A method as in claim 60, wherein the pop-up message is a confirmation or error message associated with a state

62. A method as in claim 50, wherein the mobile application provides a field for data entry associated with a state, and wherein the backwards navigation from that state omits data previously entered in the field.
